(19) United States
(12) Patent Application Publication
(10) Pub. No.: US 2021/0386219 A1
(43) Pub. Date: Dec. 16, 2021

(54) DIGITAL MIRROR

(71) Applicant: SELFIE SNAPPER, INC., SHERMAN OAKS, CA (US)

(72) Inventor: Denis KOCI, SHERMAN OAKS, CA (US)

(73) Assignee: SELFIE SNAPPER, INC., SHERMAN OAKS, CA (US)

(21) Appl. No.: 17/346,159

(22) Filed: Jun. 11, 2021

Related U.S. Application Data
(60) Provisional application No. 63/038,653, filed on Jun. 12, 2020.

(51) Int. Cl. A47G 1/02; G06T 7/11; G06T 1/00; G02B 5/08; G06T 19/00

(52) U.S. Cl. CPC A47G 1/02; G06T 7/11; G06T 19/006; G02B 5/0816; G06T 1/0007

(57) ABSTRACT

Disclosed embodiments include a digital mirror for digitally trying on one or more physical objects. The digital mirror may include a camera that captures content data of a person or other subject. A portion the person's body may then be augmented by a digital representation of an item of clothing or other physical object overlaid over the image of the person's body to simulate the appearance of trying on clothing and other objects. By augmenting the portion of the user's body with the digital representation, the digital mirror allows users to digitally try objects they see when browsing e-commerce platforms.

### RELATED APPLICATIONS

This application claims priority under 35 U.S.C. § 119(e) to U.S. provisional application No. 63/038,653 filed Jun. 12, 2020, the entirely of which is incorporated by reference. The application is related to U.S. provisional application No. 63/038,650 filed Jun. 12, 2020, the entirely of which is incorporated by reference. The application is also related to U.S. patent application Ser. No. 17/139,768 which claims priority under 35 U.S.C. § 119(e) to U.S. provisional application No. 62/956,054 filed Dec. 31, 2019; U.S. provisional application No. 63/094,547 filed Oct. 21, 2020; and U.S. provisional application No. 63/115,527 filed Nov. 18, 2020, the entirely of which are incorporated by reference. The application is also related to U.S. patent application Ser. No. 16/922,979 which claims priority under 35 U.S.C. §119(e) to U.S. provisional application No. 62/871,158 filed Jul. 7, 2019 and U.S. provisional application No. 62/956,054 filed Dec. 31, 2019, the entirely of which are incorporated by reference. The application is also related to U.S. patent application Ser. No. 16/922,983 which claims priority under 35 U.S.C. § 119(e) to U.S. provisional application No. 62/871,160 filed Jul. 7, 2019 and U.S. provisional application No. 62/956,054 filed Dec. 31, 2019, the entirely of which are incorporated by reference.

### FIELD

The present disclosure relates generally to camera systems and image processing, in particular, devices, systems, and methods for image capture and dynamic image augmentation.

### BACKGROUND

E-commerce is rapidly replacing retail shopping as the most popular platform for consumers to discover and purchase goods. Major E-commerce platforms such as AMAZON, ALIBABA, EBAY, ETSY, JD.COM, SHOPEE, and the like plus thousands of brand specific and boutique online stores enable anyone with a device connected to the Internet to browse and purchase millions of products including clothing, accessories and other items. Despite the popularity of online shopping, many consumers still prefer to shop for clothing and other items in a retail store. Seeing, touching, trying on, and otherwise interacting with a product before purchasing it is an essential part of the shopping experience for many consumers.

Many consumers still try on clothing bought online before deciding to keep it. To provide consumers the opportunity to physically try on clothes purchased digitally, e-commerce platforms invest billions of dollars in infrastructure and shipping costs to provide free and or subsidized returns. Even with free or cheap returns, many consumers end up keeping unwanted items because it is inconvenient to repack and ship returned items. There is therefore a need to develop a camera system that can provide a digital try on experience to consumers as part of an online shopping experience.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts an exemplary system that provides a digital mirror for trying on virtual clothing items.

FIG. 2 depicts an exemplary system that provides a digital mirror for trying on virtual accessories and other virtual non-clothing physical objects.

FIG. 3 illustrates more details of portions of the systems shown in FIGS. 1-2.

FIG. 4 illustrates more details of portions of the server systems shown in FIG. 3.

FIG. 5 illustrates an exemplary camera.

FIG. 6 illustrates an exemplary electroadhesion device for securing the camera to a target surface.

FIG. 7 illustrates an exemplary camera having an integrated electroadhesion device.

FIGS. 8-10 illustrate a camera mounted to a display using the electroadhesion device shown in FIG. 6.

FIG. 11 is a flow diagram illustrating an exemplary process for digitally trying on one or more physical objects using a digital mirror.

FIG. 12 is a flow diagram showing an exemplary process for sharing content generated using a digital mirror.

FIG. 13 is a block diagram of an illustrative computer that may be used to implement the systems of FIGS. 1-4.

FIG. 14 is a block diagram of the camera device shown in FIG. 5.

FIG. 15 is a block diagram illustrating more details of portions of the camera device shown in FIG. 5.

### DETAILED DESCRIPTION

### Exemplary Embodiments of the System

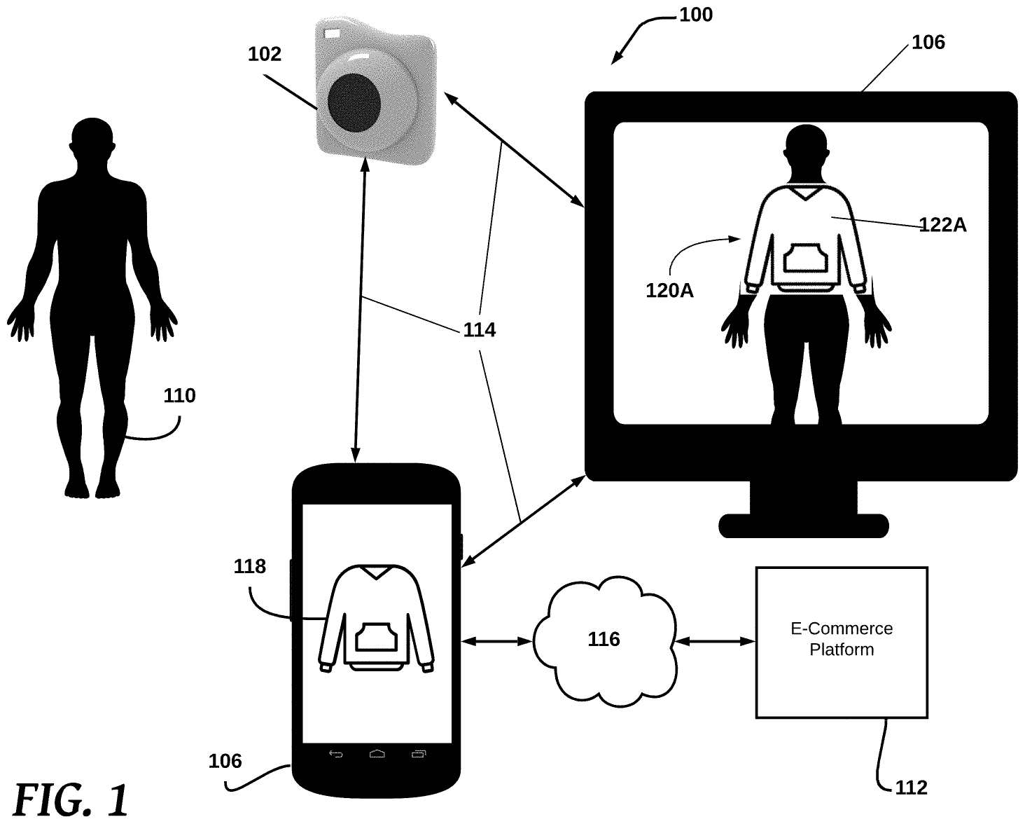

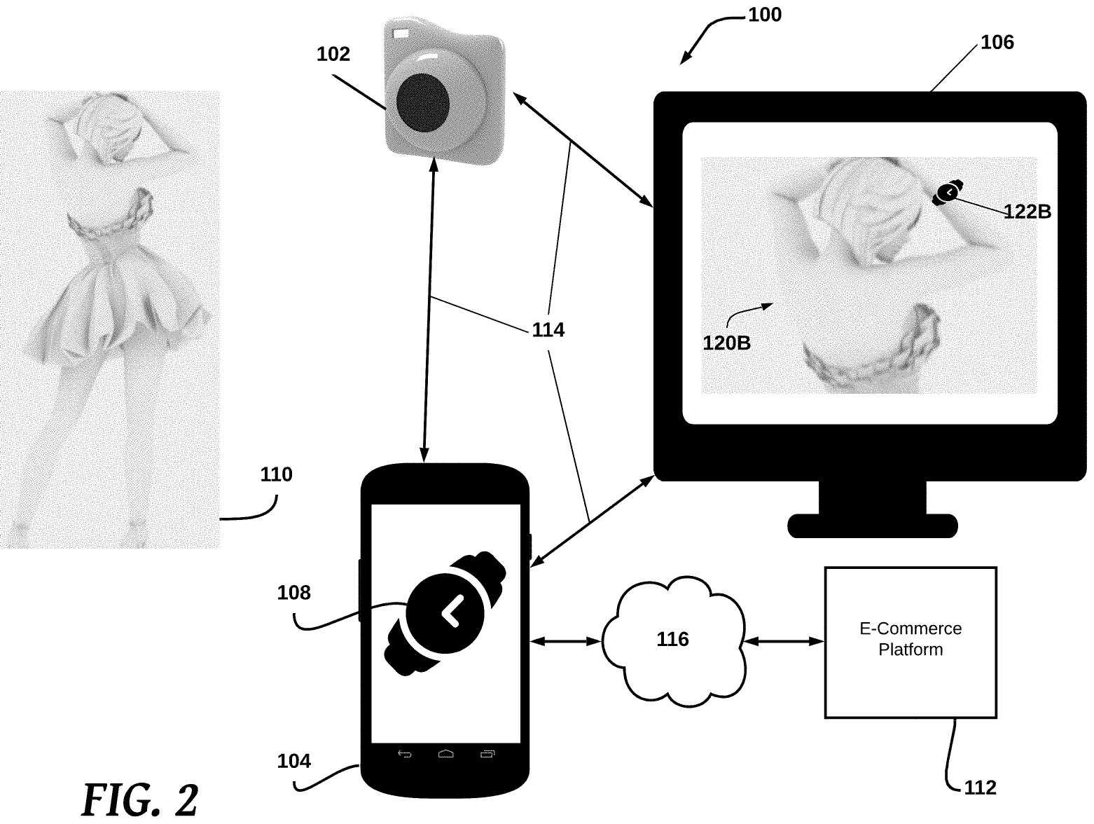

FIGS. 1-2 illustrate embodiments of a camera system 100 that provides a digital mirror. The camera system 100 may include a mechanism for attaching one or more cameras to a target surface, an apparatus that augments one or more pieces of content data captured by the one or more cameras, and an apparatus that projects augmented content data to provide a digital mirror. The one or more pieces of content data may include images, video, audio and other content capable of capture by a camera and or user device of the disclosure. Pieces of content data may be transferred as data files including image data, audiovisual data, and the like using file/data lossless transfer protocols such as HTTP, HTTPS or FTP.

The digital mirror may present one or more pieces of content data of a subject 110 augmented by one or more digital representations 122A, 122B of physical objects including articles of clothing 118, accessories 108, or other physical objects worn by the user and or adjacent to (i.e., held by the user and or otherwise close to the user's body with a portion of the object touching the user's body) the user. Augmented content data 120A, 120B of the subject 110 may be presented on a display 106, for example, a television, computer, monitor, projection screen of a projector, and or any electronics device having a display screen for viewing content. Presenting the augmented content data 120A, 120B on the display 106 may provide a digital view of the subject that resembles how the subject would look in a physical mirror when wearing the clothing or other products. The subject 110 may include people, objects, landscapes, background elements, and any other aspects of a scene that may be captured in a photo or video. Images, 3D renderings, and other content required to generate the digital representations 122A, 122B of the physical objects included in the augmented content data 120A, 120B may be received from an e-commerce platform 112 and or generated by a digital clothing client or other piece of software implemented on the user device 104 or other component of the camera system 100. For example, 3D images, image data providing a 360° of view of the physical object, and the like may be received from the e-commerce platform 112 such as AMAZON, EBAY, ETSY, ALIBABA, and the like.

As shown in FIGS. 1 and 2, the camera system 100 may include a camera 102 that captures content data of a subject including, for example, video and or images of the subject 110. The camera 102 may be communicatively coupled to display 106, a user device 104 and/or any remote computer using one or more connections 114 (e.g., a Bluetooth, Wifi, or other wireless or wired connection, and or other communications component). The user device 104 and/or remote computer may control the operation of the camera 102 using a camera controller or other piece of software. The user device 104 and/or remote computer may also include a browser application for browsing the one or more e-commerce platforms 112 to retrieve image data and other content used to generate the one or more digital representations 122A, 122B of the physical objects included in the augmented content data 120A, 120B. In various embodiments, the camera 102 may be fixed to the display 106 using an electroadhesion device, a mechanical attachment mechanism, or other attachment mechanism. The attachment mechanism may be an integrated attachment mechanism that is integrated with the camera 102. The camera 102 may also be attached to a robotic arm mounted on a rotating platform to facilitate moving the camera 102 to different positions around the subject 110 to capture different perspectives of the subject 110.

The digital representations 122A, 122B of the physical objects may be modified to fit the perspective of the subject 110 captured by the camera 102. For example, the digital representations 122A, 122B of the physical objects may include a two dimensional (2D) representation and or a three dimensional (3D) representation that is used to generate augmented content data 120A, 120B that includes a three dimensional (3D) representation of the subject 110 augmented by the digital representation 122A, 122B of the physical object. The 3D representation of the subject may be an augmented reality display that includes a 360° view the subject 110 augmented by the digital representation of the physical object. As the subject 110 moves within the field of view of the camera 102, the digital representation of the physical object may be modified to seamlessly move with the subject 110 so that the digital representation of the physical object appears attached to the subject 110. By adjusting the position of the digital representation 122A, 122B of the physical object according the movements of the subject, the augmented content data 120A, 120B generated by the camera system 100 may show the digital representation of the physical object as appearing to fit the subject 110 naturally from any perspective, pose, and or position of the subject 110. The augmented content data 120A, 120B may be projected on the display 106 so that the display 106 functions as a digital mirror that may simulate a try on experience by allowing users to view the physical object on a portion of their body to see of the physical object looks and fits.

Before augmenting the content data of the subject with the digital representation of the physical object, the camera 102 may stream a preview of the area within the field of the view of the camera 102 to the user device 104 and or display 106. The preview may include a live video preview showing the subject 110 and surrounding area captured by the camera 102. The preview may also include a static and or dynamic image captured by the camera 102. The user device 104 may also generate a preview of the augmented content data on the user device 104 before the augmented content data is projected on the display 106. The preview of the augmented content data 120A, 120B may be used to capture a piece of content of the subject 110 augmented with the one or more digital representations 122A, 122B of clothing 118, accessories 108, and or other physical objects. After capture, the piece of content may be recorded in memory and or stored on the user device and or transmitted to a social media platform as part of a social media post. The social media platform may include, for example, TWITTER, FACEBOOK, SNAPCHAT, INSTAGRAM, TIKTOK, WECHAT, LINE, and the like.

The user device 104 may be a processor-based device with memory, a display, and wired and or wireless connectivity circuits that allow the user device 104 to communicate with the camera 102, the display 106, the e-commerce platform 112, and one or more other platforms or services (e.g., a social media platform) via a communications path 116. The communications path 116 may include one or more wired or wireless networks/systems and/or other communications components (e.g., wired and or wireless connectivity circuits) that allow the user device 104 to communicate with a remote service, platform, computer system, and the like using a known data and transfer protocol. The user device 104 may use the wired and or wireless connectivity circuits to interact/exchange data with the camera 102, the display 106, e-commerce platform 112, and or other platforms or services. For example, the user device 104 may communicate a control command or other message to operate the camera 102, for example, to adjust one or more aspects of the camera 102 (e.g., focus, field of view, illumination, and the like) and or to position the camera's field of view to include the subject 110. The control command may encode a particular operation of the camera and the user device 104 may transmit one or more control commands to a communications component of the camera to operate the camera 102. In response to sending a control command, the user device 104 may receive a confirmation from the camera 102 that the control command has been executed and or the camera 102 has been adjusted according to the control command. The user device 104 may then communicate a subsequent control command to the camera 102 to capture content data of the subject and, in response, may receive a confirmation and or a preview of the content data captured by the camera 102. The user device 104 may then augment the content data with one or more digital representations 122A, 122B of physical objects to generate augmented content data 120A, 120B. The user device may then transmit the augmented content data 120A, 120B to the display 106 to project the augmented content data 120A, 120B on the display.

The user device 104 may be a smartphone device, such as an APPLE IPHONE product or an ANDROID OS based system, a personal computer, a laptop computer, a tablet computer, a terminal device, and the like. As described in detail below, the user device 104 may have one or more pieces of software (e.g., a web app, mobile app, digital clothing client, or other piece of software) that are executed by the processor of the user device 104 to perform the functions of the camera system 100 to provide the digital mirror. These functions may include, operating the camera 102, displaying content data captured by the camera 102, generating augmented content data 120A, 120B, projecting the augmented content data 120A, 120B on a display 106, capturing one or more pieces of content of the subject 110 augmented with one or more digital representations 122A, 122B of physical objects, and or sharing the one or more pieces of content to a social media platform. The one or more pieces of software may provide a user interface (UI) for controlling the camera system 100 to generate the digital mirror, operating the camera 102, displaying content data captured by the camera 102, generating augmented content data 120A, 120B, projecting the augmented content data 120A, 120B on a display 106, capturing one or more pieces of content of the subject 110 augmented with one or more digital representations 122A, 122B of physical objects, and or sharing the one or more pieces of content to a social media platform as described in detail below.

In one embodiment, the camera 102 may include one or more pieces of software for performing the functions of the digital mirror system. The camera 102 may have a processor and memory storing instructions that may be executed by the processor to perform the functions of the digital mirror system. For example, the processor of the camera 102 may execute instructions for operating the camera 102, displaying content data captured by the camera 102, generating augmented content data 120A, 120B, projecting the augmented content data 120A, 120B on a display 106, capturing one or more pieces of content of the subject 110 augmented with one or more digital representations 122A, 122B of physical objects, and or sharing the one or more pieces of content to a social media platform.

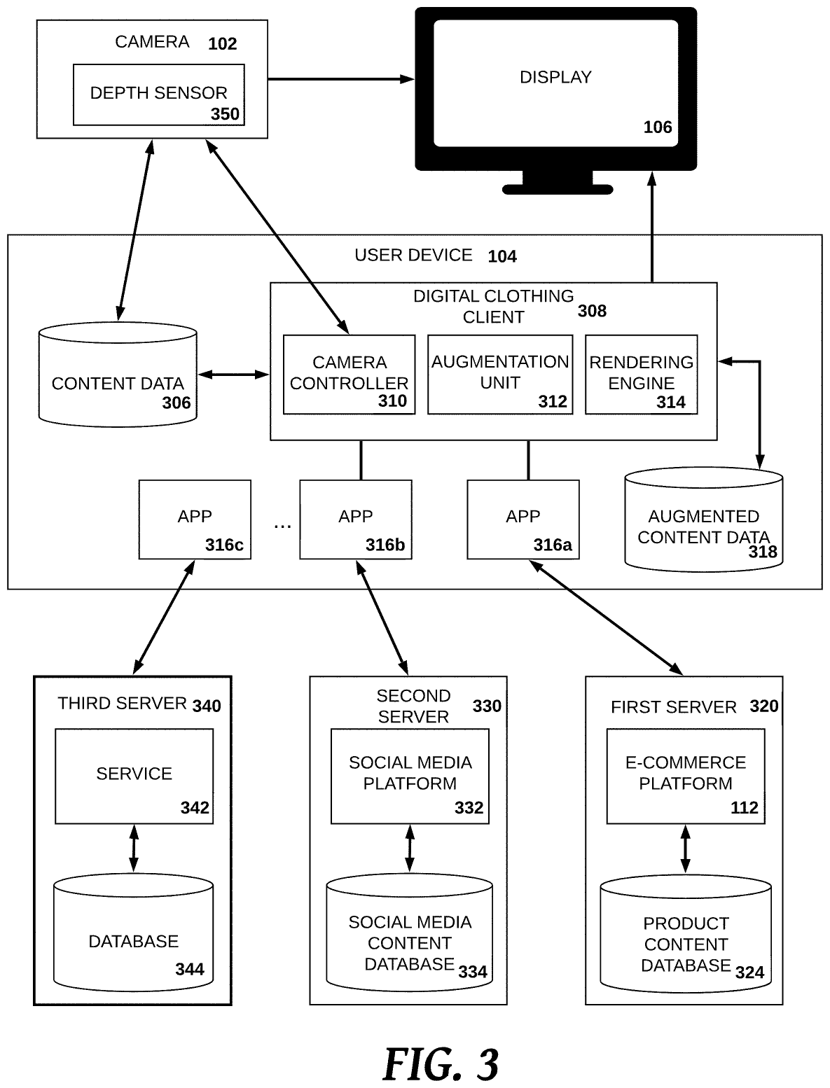

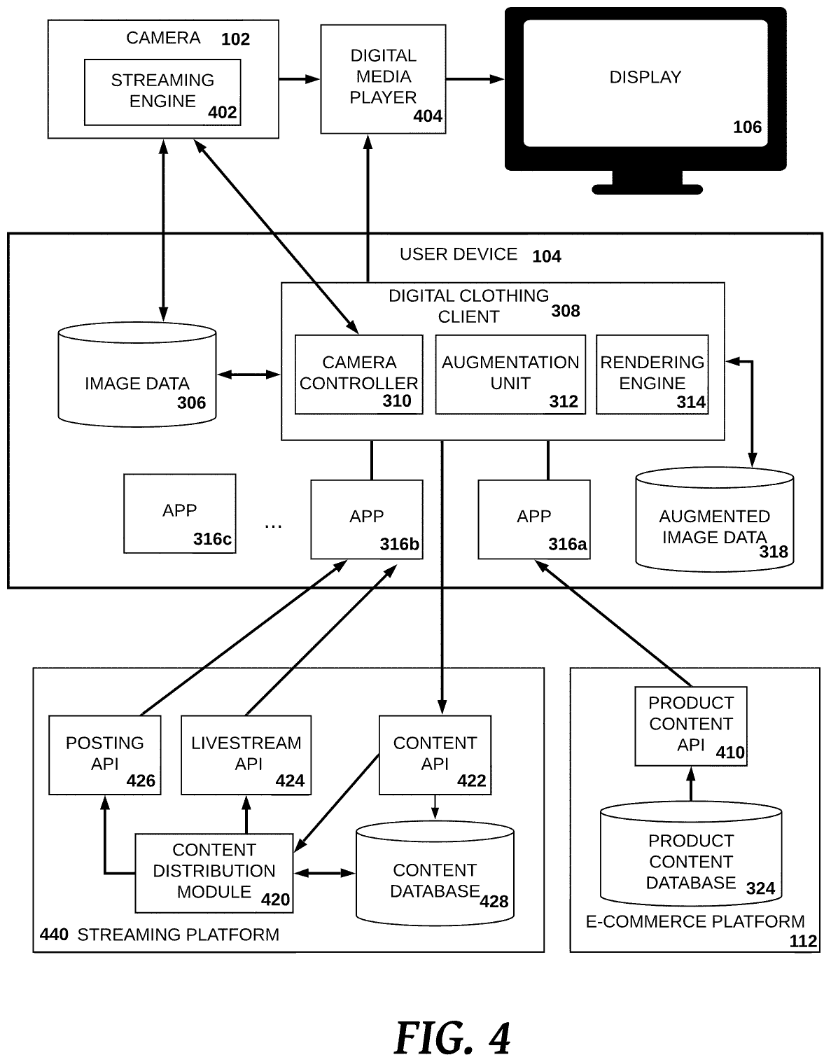

FIGS. 3-4 illustrate more details of the camera system 100 that provides a digital mirror shown in FIGS. 1-2. In particular, FIG. 3 illustrates more details of the user device 104 and FIG. 4 illustrates more details of the e-commerce platform 112 and other services that interface with the user device 104. The components shown in FIGS. 3-4 provide the functionality delivered by the hardware devices shown in FIGS. 1-2. These components may be included in the user device 104 as shown and or may be integrated into the camera 102. As used herein, the term “component” may be understood to refer to computer executable software, firmware, hardware, and/or various combinations thereof. It is noted that where a component is a software and/or firmware component, the component is configured to affect the hardware elements of an associated system, It is further noted that the components shown and described herein are intended as examples. The components may be combined, integrated, separated, or duplicated to support various applications. Also, a function described herein as being performed at a particular component may be performed at one or more other components and by one or more other devices instead of or in addition to the function performed at the particular component, Further, the components may be implemented across multiple devices or other components local or remote to one another. Additionally, the components may be moved from one device and added to another device or may be included in both devices.

FIG. 3 illustrates more details of the user device 104 shown in FIGS. 1-2. As shown, the user device 104 may include a digital clothing client 308 that controls the camera 102 and generates the augmented content data 120A, 120B. The digital clothing client 308 may be implemented as a client, application, or other piece of software that is executed by a processor included in the user device 104 and or the camera 102. The digital clothing client 308 may include a camera controller 310 that controls the camera 102. The camera controller 310 may include a wired and or wireless communications interface for sending and receiving data to and from the camera 102 via any known communications protocol (e.g., WiFi, Bluetooth, TCP/IP, and the like). The camera controller 310 may send and receive control commands or other messages or data from the camera 102 to control camera functionality. For example, the camera controller 310 may receive a notification from the camera 102 indicating when camera 102 is powered on and located close enough to the user device 104 to establish a connection with the user device 104. In response, the camera controller 310 may send a control command containing a connection request to establish a communication path with the camera 102. The camera controller 310 may send control commands for adjusting one or more camera settings zoom, flash, illumination, aperture, aspect ratio, contrast, resolution, exposure rate, and the like) of the camera 102. The camera controller 310 may also send control commands or other messages or digital data to cause the camera 102 to adjust position, turn on, turn off, start capturing content data (e.g., record video, stream video, capture images, and the like), stop capturing content data, share content data, and or perform other operations.

The camera controller 310 may interface with the display 106 to synchronize capture of content data with projection of augmented content data on the display. For example, the camera controller 310 may perform one or more synchronization operations to ensure live video captured by the camera 102 is dynamically augmented with one or more 2D and or 3D digital representations of the physical objects (e.g., in real time or within less than one second of capture) so that the movements of the subject captured in the live video or other content data can be displayed as augmented content data on the display 106.

The user device 104 may connect to the camera 102 via the communications interface to receive content data (e.g., images, videos, and the like). Content data received from the camera 102 may be stored in a content data store 306 and or recorded in memory. The content data store 306 may store content data in various ways including, for example, as a flat file, indexed file, hierarchical database, relational database, unstructured database, graph database, object database, and/or any other storage mechanism. The content data store 306 may be implemented as a portion of the user device 104 and or camera 102 hard drive or flash memory (e.g., NAND flash memory in the form of eMMCs, universal flash storage (UFS), SSDs etc.).

To generate augmented content data, the user device 104 may include an augmentation unit 312 and a rendering engine 314. The augmentation unit 312. and rendering engine 314 may be implemented as a piece of software including a stand-alone mobile app installed on the user device 104 and or camera 102, a stand-alone web app accessible by an web browser application, and or as a plug-in or other extension of another application or other software installed on the user device 104 or camera 102 (e.g., a naïve camera application, photo application, photo editing application, and the like). The augmentation unit 312 and rendering engine 314 may be communicatively coupled to the camera 102 and or a plurality of other apps (316a, 316b, 316c, etc.) included in the user device 104.

To generate augmented content data, the augmentation unit 312 and rendering engine 314 may modify content data to by adding one or more 2D and or 3D digital representations of physical objects to a portion of the subject captured in the content data. For example, content data captured by the camera 102 may be received by the augmentation unit 312 and or other component of the digital clothing client 308. The augmentation unit 312 may also receive a digital representation of a piece of clothing, accessory, or other physical object. The digital representation of the physical object may be 2D and or 3D content data (e.g., a 360° image, a 3D image, a static image and a depth map corresponding to the static image, stereo images, virtual reality (VR) rendering, augmented reality (AR) rendering, and the like). The digital representation may be received from an application or other piece of software executed by the user device, for example, a video, photo, or other content data captured by a native camera application or an image, 360° view, or other content displayed on an e-commerce application 316a. The digital representation may also be received from a stand-alone content data editing application that modifies image data and other content received from one or more applications (e.g., the native camera application and or the e-commerce application) to generate the digital representation of the physical object. The augmentation unit 312 and or digital clothing client 308 may also include built-in functionality for generating a digital representation of the physical object for one or more pieces of image data and or content captured and or received by the user device 104.

Once the content data of the subject and the digital representation of the physical object is received, the augmentation unit 312 may generate augmented content data by combining the content data of the subject and the digital representation of the physical object. One or more previously known and or proprietary image process techniques may be used to generate the augmented content data. For example, multiple pieces of content data of the subject and or physical object may be combined to generate augmented content data including a 3D representation of the subject augmented by the physical object.

In other embodiments, the augmentation unit 312 may perform one or more image segmentation operations to separate the subject and or a portion of the subject from the background and determine the distance from the camera (i.e., depth) of every aspect of the subject (e.g., each part of the subject's body). For example, the augmentation unit 312 may perform one or more segmentation operations to segment a portion of the subject from a remaining portion of a piece of content (e.g., a background of an image, video and or image data stream). The augmentation unit 312 may use the one or more segmentation operations to separate the piece of content received from the camera 102 into a segmented portion that includes the portion of the subject to be augmented by the digital mirror and a remaining portion the includes the background of the piece of content and the other portions of the piece of content that are not augmented with one or more pieces of digital clothing, digital accessories, and or other digital objects.

The image segmentation operations may include one or more image segmentation techniques that are known in the art and or proprietary image segmentation approaches. The facilitate the one or more image segmentation operations, the camera 102 may include a depth sensor 350 that operates to measure depth data of one or more objects included in the content data of the subject. The depth data may then be used to calculate a distance from the camera 102 of one or more objects included in the content data of the subject. For example, the depth sensor 350 may measure the distance away from the camera 102 of the subject. The depth sensor 350 may include a time of flight (TOF) sensor, a dot field projector, a stereoscopic camera, an infrared camera, a Lidar system, and or other structured light sensor or emissions-based depth sensor. The depth data collected by the depth sensor 350 may be transmitted to the user device 104 and or camera 102 and used to separate the subject and or the portion of the subject that is to be augmented by the digital representation of the physical object from the remaining portion of the content data of the subject. The depth data may also be used to modify the 2D and or 3D digital representation of the physical object to follow the motion of the subject so that the digital representation of the physical object appears attached to the portion of the subject that is covered by the digital representation.

Once the edges, location, and depth of the subject captured in the content data are determined, the augmentation unit 312 may scale the digital representation of the physical object to match the size of the subject. For example, the augmentation unit 312 may use the depth data measured by the depth sensor 350 to determine the distance away from the camera 102 of the subject. The augmentation unit 312 may then scale the digital representation of the physical object based on the subject's distance and/or the distance of the segmented portion from the camera so that the digital representation covers the entire portion of the subject that would be covered if the subject was actually wearing the physical object in the physical world. Scaling the size of the digital representation of the physical object to match the depth of the subject ensures the digital representation of the physical object fits the subject and does not appear too big and cover a greater portion of the subject than the physical object would in the physical world. Scaling the size of the digital representation to match the size of the subject also ensures the digital representation of the physical object does not appear too small and cover a smaller portion of the subject that the physical object would in the physical world.

Once the size of the digital representation of the physical object is determined, the augmentation unit 312 may then map the digital representation of the physical object to the area of the subject where the digital representation of the physical object is supposed to appear (i.e., the portion of the subject and/or piece of content included in the segmented portion). For example, the augmentation unit 312 may map a digital representation of a sweater to appear over the torso of the subject or a digital representation of a watch to appear over the wrist of the subject. The augmentation unit 312 may map the digital representation of the physical object to the segmented portion of subject using any known image or other content data mapping technique, for example, pixel matching which maps individual pixels in the digital representation of the physical object to individual pixels that make up the location of the subject where the digital representation of the physical object is supposed to appear. The augmentation unit 312 may perform one or more mapping operations to generate a mapping file the provides mapping locations, image transformations, and other instructions for overlaying the digital representation of the physical object over the desired location on the subject (i.e., the portion of the subject and/or piece of content included in the segmented portion).

The rendering engine 314 may then receive the mapping file and execute the instructions included in the mapping file to generate an augmented reality (AR) representation and or AR display or other augmented content data that shows the digital representation of the physical object overlaid on the subject. Each time the subject moves and/or the segmented portion of the subject changes position in the content data captured by the camera 102, the rendering engine 314 may dynamically modify the mapping file in response to the change in position by the segmented portion of the subject. For example, the rendering engine may execute a different set of instructions in the mapping file to adjust the position of the digital representation of the physical object so that it appears attached to the subject and appears to naturally fit the subject at every pose and or position. Techniques for fitting digital objects to particular portions of content data are known in the art, for example, techniques developed by AMAZON and ZAZZLE. To generate augmented content data, the digital clothing client 308 may use any known technique from a third party and or propriety techniques developed in-house. The augmented reality displays generated by the rendering engine 314 may be included in augmented content data stored in the augmented content data store 318 and or recorded in memory of the user device 104 or camera 102. The digital clothing client 308 may transmit the augmented content data to the display 106 using a wired and or wireless communications interface to project the augmented content data on the display 106.

The user device 104 may include one or more applications (e.g., apps 316a, 316b, 316c) that provide additional functionality. For example, the user device may include an e-commerce app 316a that displays physical objects (e.g., clothing, accessories, and other objects) for sale on an e-commerce platform 112. If a user wants to try on a physical object on the e-commerce app 316a, the camera 102 may capture images, video, and other content data of the user and the digital clothing client 308 may generate augmented content data showing the physical object overlaid on a portion of the body the user of other aspect of the content data. The augmented content data may then be projected on the display 106 to simulate a clothing try on experience in the physical world. The projected augmented content data may mimic how the user would appear standing in front of a physical mirror when trying on the physical object in a store to provide a digital try on experience. Users may also use the digital mirror provided by the camera system to simulate the appearance objects such as toys, furniture, appliances, plants, and the like positioned within a room or other space captured by the camera 102.

The user device 104 may also include a social media app 316b that enables the user device 104 to access a social media platform 332. The digital clothing client 308 may connect to the social media app 316b via an application programming interface (API) or other interface or connection to share augmented content data generated by the digital clothing client 308 on the social media platform 332. Augmented content data may be shared, for example, as a static photo, dynamic, photo, video or other media included in a social media post distributed on the social media platform 332. The user device 104 may also include one or more other apps 316c that provide additional functionality, for example, a native camera app for operating a native camera included in the user device, an image or other content data editing app, a messenger app, and the like.

Each app 316 on the user device 104 may interface with one or more computer servers to send and receive data and provide the functionality of the app 316. The apps 316 may communicate the servers via any known wired and or wireless connection for example a wireless network connection. Communication between the apps 316 and the servers may be facilitated by one or more APIs. The APIs may be proprietary and or may be examples available to those of ordinary skill in the art such as AMAZON® Web Services (AWS) APIs or the like. The network connection may be an Internet connection and or other public or private network connection or combinations thereof.

The first server 320 may be configured to implement the e-commerce platform 112, which in one embodiment may be used to browse and purchase products and or retrieve one or more pieces of content used to generate a digital representation of any physical object for sale on the e-commerce platform 112. The one or more pieces of content used to generate the digital representation may be stored in a product content database 324. The first server 320 may provide the one or more pieces of content to the e-commerce app 316a. The second server 330 may be configured to implement the social media platform 332, which may be used to browse and share content from and to a social media network. The content distributed on the social medial platform 332 may be stored in a social medial content database 334. The second server 330 may receive one or more pieces of content (e.g., augmented content data) from the social media app 316b and distribute the content on the social media platform 332. The third server 340 may implement a service that provides functionality of one or more of the other apps 316c on the user device 104. Data sent to a received from the one or more other apps 316c may be stored in a database 344. The apps 316 may be configured to present user interfaces (UIs) and receive input thereto for controlling functionality of the apps. The first server 320, second server 330, third server 340, e-commerce platform 112, social media platform 332, service 342, product content database 324, social medial content database 334, database 344, user device, and components of the user device 104 each depicted as single devices for ease of illustration, but those of ordinary skill in the art will appreciate that first server 320, second server 330, third server 340, e-commerce platform 112, social media platform 332, service 342, product content database 324, social medial content database 334, database 344, user device 104, and components of the user device 104 may be embodied in different forms for different implementations. For example, any or each of first server 320, second server 330, and or third server 340 may include a plurality of servers or one or more of the commerce platform 112, social media platform 332, service 342, product content database 324, social medial content database 334, database 344. Alternatively, the operations performed by any or each of first server 320, second server 330, third server 340 may be performed on fewer (e.g., one or two) servers. In another example, a plurality of user devices 104 may communicate with the first server 320, second server 330, and or third server 340. A single user may have multiple user devices 104, and/or there may be multiple users each having their own user device(s) 104.

FIG. 4 illustrates more details of components for streaming content and interfacing with the e-commerce platform 112. As shown, the camera 102 may include a streaming engine 402 for streaming content captured by the camera 102. When executing a command to stream a piece of content (e.g., a video), the camera 102 may initiate a connection with a remote server (e.g., a streaming platform server) of a streaming platform 440. Once connected to the streaming platform 440, the camera 102 may transfer videos and other content to the streaming platform via a content API 422 for distribution to a plurality of streaming platform clients using a content distribution module 420. For example, the content distribution module 420 may stream content captured by the camera to a smartphone, smart tv, or other device (e.g., the user device 104 and or digital media player 404) executing an instance of the streaming platform client. For example, the content distribution module 420 may interface with a streaming client of the social media app 316b via. a livestream API 424 to stream content captured by the camera 102. The camera 102 may also connect to a digital media player 404 to project content captured and or streamed by the camera on a display 106. The digital media player 404 may be, for example, an APPLE TV, ROKU, AMAZON FIRE, CHROMECAST, or other device that plays digital content on a television, monitor, or other display.

In various embodiments, the camera 102 may also provide video and other content for streaming to the content data store 306. The digital clothing client 308 may facilitate streaming content by interfacing with the content API 422 of the streaming platform 440. To stream one or more pieces of content included in the content data store 306 and or the augmented content data store 318, the digital clothing client 308 of the user device 104 may retrieve a piece of content for streaming, for example, a piece of augmented content data (i.e., a video of a subject augmented with one or more digital representations of the physical objects) and transfer the piece of augmented content data to a content API 422. The piece of content for streaming may be transferred to the content API 422 using a file/data lossless transfer protocol such as HTTP, HTTPS or FTP. The piece of content for streaming may then be provided to a content distribution module 420 for distribution to a plurality of clients through a livestream API 424 and/or stored in a content database 428. The content distribution module 420 and/or the livestream API 424 may include a media codec (e.g., audio and/or video codec) having functionality for encoding video and audio received from the camera 102 and or the user device 104 into a format for streaming (e.g., an audio coding format including MP3, Vorbis, AAC, Opus, and the like and/or a video coding format including H.264, HEVC, VP8 or VP9) using a known streaming protocol (e.g., real time streaming protocol (RTSP), real-time transport protocol (RTP), real-tune transport control protocol (RTCP), and the like). The content distribution module 420 and/or livestream API 424 may then assemble encoded video streams in a container bitstream (e.g., MP4, WebM, ASF, ISMA, and the like) that is provided by the livestream API 424 to a plurality of streaming clients using a known transport protocol (e.g., RTP, RTMP, HLS by Apple, Smooth Streaming by Microsoft, MPEG-DASH by Adobe and the like) that supports adaptive bitrate streaming over HTTP or other known web data transfer protocol.

The pieces of content provided to the streaming platform by the camera 102 and or user device 104 may also be distributed to a social media platform. For example, a posting API 426 include instructions for formatting the pieces of content to match specifications for content distributed on one or more social media platforms. The specifications may be obtained by parsing GUIs included in one or more social media platforms (e.g., GUIs included in mobile app and or web app versions of social media platforms). For example, the specifications may be obtained parsing HTML, CSS, XML, JavaScript, and the like elements rendered as web app GUIs to extract file size, resolution, aspect ratio, and other specifications of content posts displayed in web app implementations of social media platforms and/or video streaming platforms. The specifications of mobile app content posts may be obtained by parsing Swift, Objective C, and the like elements (for iOS apps) and/or Java, C, C++, and the like elements (for Android apps). The posting API 426 may then re-format the pieces of content to create a realistic preview of how an image or livestream video will look on a social media platform and/or video streaming platform. For example, the posting API 426 may crop content to a size and/or aspect ratio that matches the size and/or aspect ratio of a particular GUI (e.g., post GUI, content feed GUI, live stream GUI, and the like) included in a web app and/or mobile app implementation of a social media and/or video streaming platform. The posting API 426 may also change the resolution of content received from the camera 102 and or digital clothing client 308 to match the resolution of content displayed in a particular GUI included in a web app and/or mobile app implementation of a social media and/or video streaming platform.

The posting API 426 can include functionality for configuring previews projected on the user device display to match the orientation of the user device display. For example, the posting API may access a motion sensor (e.g., gyroscope, accelerometer, and the like) included in the user device 104 to determine the orientation of a user device display. The posting API 426 may then crop the preview video feed and/or captured content received from the camera 102 to fit the aspect ratio of the user device display at its current orientation. The posting API 426 may dynamically crop the previews and/or captured content from the camera 102 to match the orientation of the user device display to dynamically change the aspect ratio of the previews and/or captured content, for example, from portrait to landscape when the user device display rotates from a portrait orientation to a landscape orientation.

The preview generated by the posting API 426 may incorporate one or more specifications of content posted on a social media and/or video streaming platform. For example, the preview may modify the pieces of content to simulate cropping that occurs when sharing the pieces of content on a content streaming GUI (e.g., SNAPCHAT snaps, INSTAGRAM stories, FACEBOOK stories, and the like) included in a social media and/or content streaming platform. The preview may modify landscape content to simulate cropping that occurs when sharing wide angle content (e.g., a group photo/video captured in a landscape orientation) to a social media and/or video streaming platform. Previews generated by the posting API 426 may be stored in the content database 428 and or distrusted to a social media platform using as file/data lossless transfer protocols such as HTTP, HTTPS or FTP. For example, a social media platform implemented in the social media app 316b.

To generate augmented content data, the digital clothing client 308 may receive image data or other content data of a physical object. The image data of the physical object may be received from an e-commerce app 316a. For example, a GUI of an e-commerce app 316 for browsing and or purchasing the physical object. The content data of the physical object may be distributed to the e-commerce app 316a by an e-commerce platform 112 via a product content API 410. The product content API 410 may retrieve the content data of the physical object from the product content database 324 and distribute the content data to the e-commerce app 316a for display in a GUI for browsing and or purchasing the physical object.

To generate augmented content data included the physical object, the digital clothing client 308 may retrieve the content data from the e-commerce app 316a. The augmentation unit 312 may then generate a 3D representation of the physical object using the content data obtained from the e-commerce app 316a. The augmentation unit 312 may then augment content data of the subject captured by the camera 102 with the 3D representation of the physical object and the rendering engine may render augmented content data. For example, the augmented content data generated by the rendering engine 314 may be a piece of augmented reality content that displays the 3D representation of the physical object over a portion of a subject included in the content data captured by the camera 102 that corresponds to a position where the physical object would be worn by the subject. The digital clothing client 308 may project the augmented content data on a display 106 by connecting to a digital media player 404 and streaming the augmented content data to the display 106 using the digital media player 404.

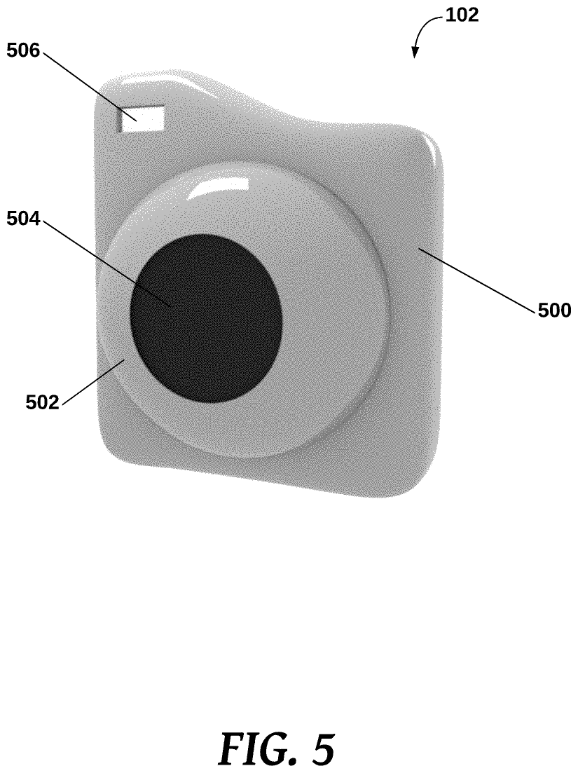

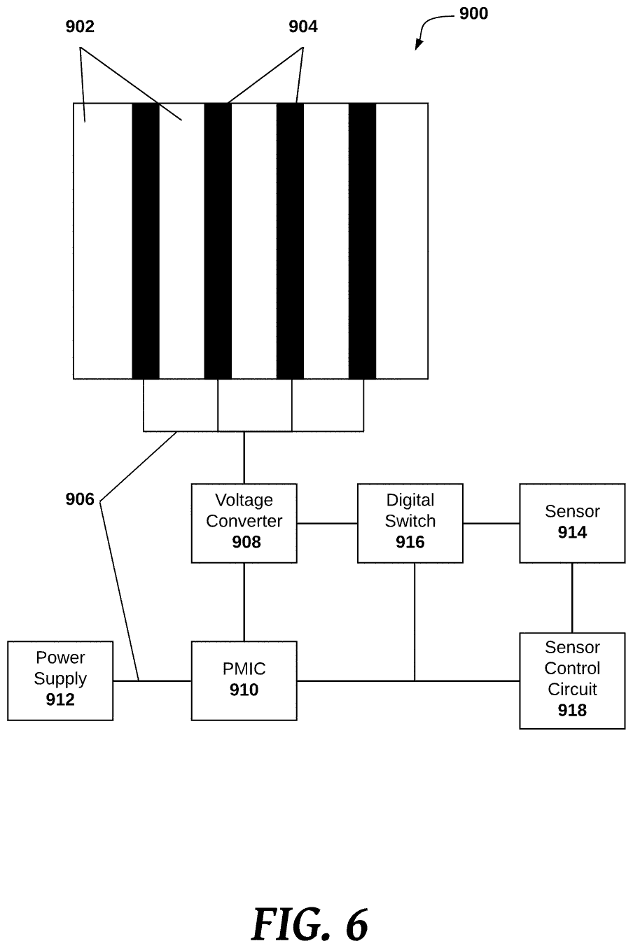

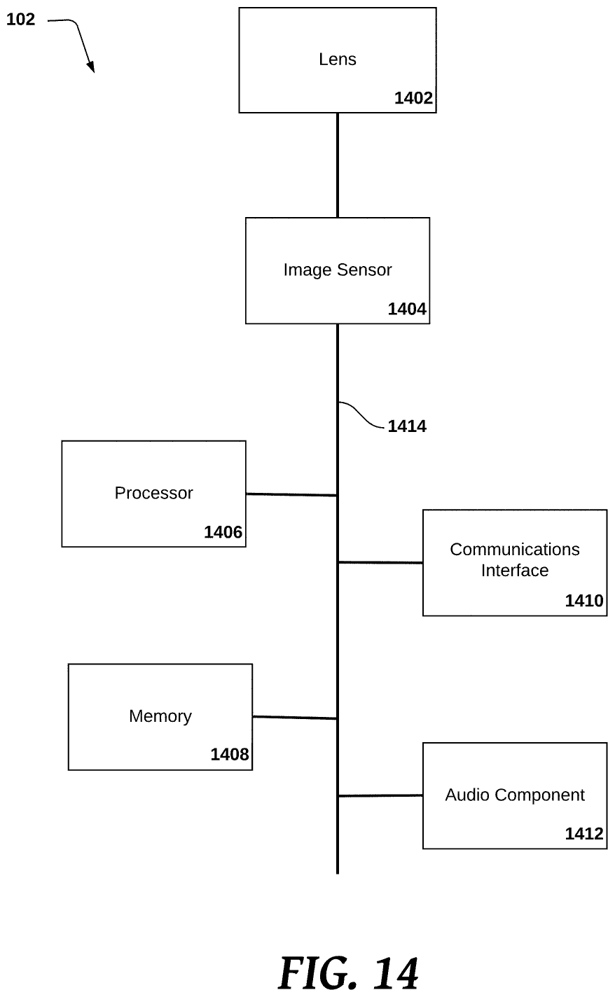

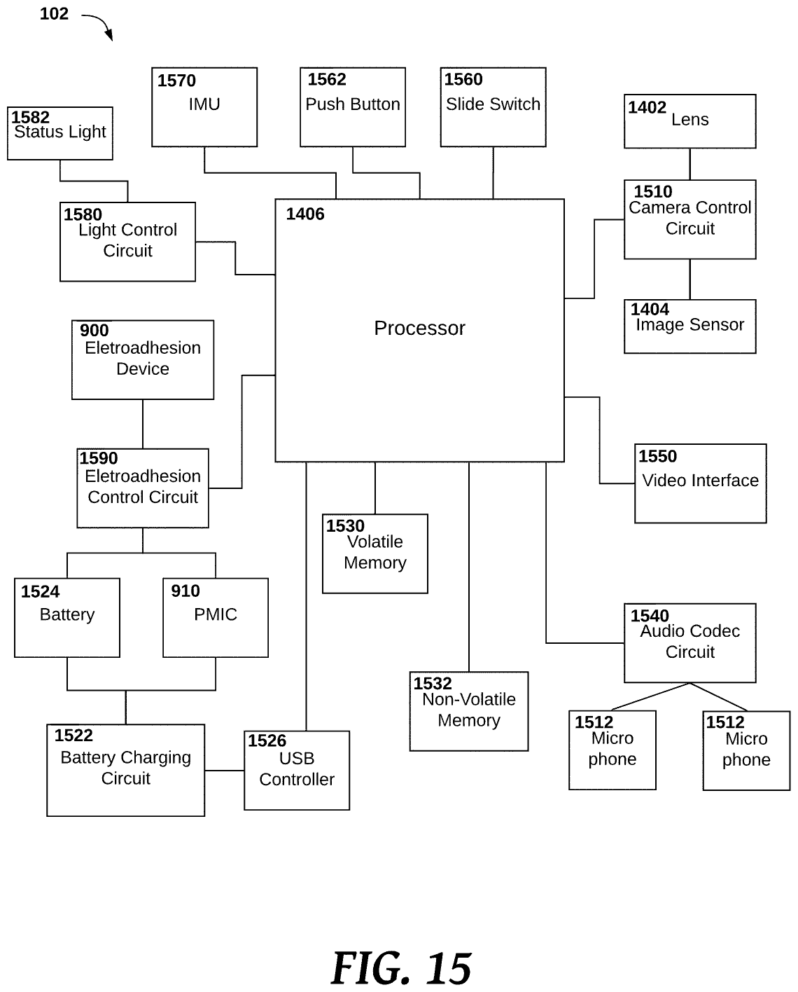

FIG. 5 illustrates one example embodiment of the camera 102. The camera 102 may include a housing 500 that encloses a circuit board including the electrical components (e.g., processor, control circuits, power source, image sensor, and the like) of the camera 102. The housing 500 may include an eye portion 502 extending laterally out from the surface of the housing. The eye portion 502 may include one or more camera components (e.g., lens, image sensor, and the like). A distal end of the eye portion 502 includes an opening 504 to allow light to pass through the lens and reach the image sensor disposed inside the housing 500 and/or eye portion 502. An LED light 506 may be embedded in an exterior surface of the housing 500 to provide additional light (i.e., flash) to enable content capture in low light conditions. More details about the components of the camera 102 are described below in FIGS. 14-15. One or more mounting systems may be attached to the backside of the housing 500 opposite the eye portion 502. The mounting systems may fix the camera 102 to one or more foreign surfaces, for example, the surface of the display, a camera attachment platform of the robotic arm, to position the camera 102 for capturing content. Mounting systems of the camera 102 may be compatible with any surface of the display or the camera attachment platform of the robotic arm to secure the camera 102 to the display and or robotic arm. The mounting system of the camera may include mechanical attachment mechanisms and or an electroadhesion attachment mechanism formed on the back of the camera 102. FIGS. 6-10 below describe an exemplary electroadhesion attachment mechanism of the disclosure.

FIGS. 6-10 pertain to electroadhesion mounting systems for securing the camera 102 to a foreign surface, for example any surface of the display or camera attachment platform of the robotic arm.

FIG. 6 illustrates an electroadhesion device 900 that may be included in the camera 102. In various embodiments, the electroadhesion device 900 can be implemented as a compliant film comprising one or more electrodes 904 and an insulating material 902 between the electrodes 904. The electroadhesive film may include a chemical adhesive applied to the insulating material 902 and/or electrodes 904 to allow the electroadhesion device 900 to be attached to the back of the camera 102. The electroadhesion device 900 may also be integrated in to the display 106, for example, a television, to allow the camera 102 to be removably attached to the display 106. For example, the electroadhesive film may be applied to a surface of the display so that the camera 102 may be attached to surface of the display using the electroadhesive film.

Additional attachment mechanisms used to secure the electroadhesion device 900 to the camera 102 and/or display 106 may include a mechanical fastener, a heat fastener (e.g., welded, spot welded, or spot-melted location), dry adhesion, Velcro, suction/vacuum adhesion, magnetic or electromagnetic attachment, tape (e.g.: single- or double-sided), and the like. Depending on the degree of device portability desired or needed for a given situation and the size of the electroadhesion device 900, the attachment mechanism may create a permanent, temporary, or removable form of attachment.

The insulating material 902 may be comprised of several different layers of insulators. For purposes of illustration, the electroadhesion device 900 is shown as having four electrodes 904 in two pairs, although it will be readily appreciated that more or fewer electrodes 904 can be used in a given electroadhesion device 900. Where only a single electrode 904 is used in a given electroadhesion device 900, a complimentary electroadhesion device having at least one electrode of the opposite polarity is preferably used therewith. With respect to size, the electroadhesion device 900 shown in FIG. 6 is substantially scale invariant. That is, electroadhesion device 900 sizes may range from less than 1 square centimeter to greater than several meters in surface area. Even larger and smaller surface areas are also possible, and the electroadhesion device 900 may be sized to the needs of a given camera system, camera, display and/or robotic arm.

In various embodiments, the electroadhesion device 900 may cover the entire rear surface of the camera and or the entire front, top, back, side, or some combination of surfaces of the display. The electroadhesion device 900 may also be sized to cover only a portion of a surface of the camera and or display. One or more electrodes 904 may be connected to a power supply 912 (e.g., battery, AC power supply, DC, power supply and the like) using one or more known electrical connections 906. A power management integrated circuit (PMIC) 910 may manage power supply 912 output, regulate voltage, and control power supply 912 charging functions. To create an electroadhesive force to support the camera, low voltage power from a power supply must be converted into high voltage charges at the one or more electrodes 904 using a voltage converter 908. The high voltage charges on the one or more electrodes 904 forms an electric field that interacts with a target surface in contact with—and/or proximate to—the electroadhesion device 900. The electric field may locally polarize the target surface and/or induce direct charges on the target surface that are opposite to the charge on the one or more electrodes 904. The opposite charges on the one or more electrodes and the target surface attract causing electrostatic adhesion between the electrodes and the target surface. The electroadhesion device 900 may cause electrostatic adhesion between the electrodes and any target surface, for example, a surface of the display, a wall, a mirror, a robotic arm, and the like. The target surface may be comprised of any material including wood, metal, stone, glass, plastic, and the like. The induced charges on the target surface may be the result of a dielectric polarization or from weakly conductive materials and electrostatic induction of charge. In the event that the target surface is a strong conductor, such as copper for example, the induced charges may completely cancel the electric field. In this case, the internal electric field is zero, but the induced charges nonetheless still form and provide electroadhesive force (i.e., Lorentz forces) for the electroadhesion device 900.

Thus, the voltage applied to the one or more electrodes 904 provides an overall electroadhesive force, between the electroadhesion device 900 and the material of the target surface. The electroadhesive force holds the electroadhesion device 900 on the target surface to hold the camera in place. The overall electroadhesive force may be sufficient to overcome the gravitational pull on the camera such that the electroadhesion device 900 may be used to hold the camera aloft on the target surface. In various embodiments, a plurality of electroadhesion devices may be placed against a target surface, such that additional electroadhesive forces against the surface can be provided. The combination of electroadhesive forces may be sufficient to lift, move, pick and place, or otherwise handle the camera and or target surface. The electroadhesion device 900 may also be attached to other structures and/or objects and hold these additional structures aloft, or it may be used on sloped or slippery surfaces to increase normal or lateral friction forces.

Removal of the voltages from the one or more electrodes 904 ceases the electroadhesive force between electroadhesion device 900 and the target surface. Thus, when there is no voltage between the one or more electrodes 904, the electroadhesion device 900 can move readily on the target surface. This condition allows the electroadhesion device 900 to move before and or after the voltage is applied. Well controlled electrical activation and de-activation enables fast adhesion and detachment. For example, response times for attachment upon electrical activation and detachment upon electrical de-activation are less than about 50 milliseconds while consuming relatively small amounts of power.

Applying too much voltage to certain materials (e.g., metals and other conductors) can cause sparks, fires, electric shocks, and other hazards. Applying too little voltage generates a weak electroadhesion force that is not strong enough to securely attach the electroadhesion device 900 to the target surface. To ensure the proper adjustable voltage is generated and applied to the electrodes 904, a digital switch 916 may autonomously control the voltage converter 908. The digital switch 916 may control the voltage output of the voltage converter 908 based on sensor data collected by one or more sensors 914 included in the electroadhesion device 900. The digital switch 916 may be a microcontroller or other integrated circuit including programmable logic for receiving sensor data, determining one or more characteristics based on the sensor data, and controlling the voltage converter 908 based on the one or more characteristics. The digital switch 916 may operate the voltage converter 908 to generate, modify, set, and/or maintain an adjustable output voltage used to attach the electroadhesion device 900 to a target surface.

For example, in response to detecting a conductive target surface (e.g., metal) by the sensor 914. the digital switch 916 may cause the voltage converter 908 to generate an adjustable voltage sufficient to attach and secure the electroadhesion device 900 to the conductive target surface. The adjustable voltage output generated in response to detecting the conductive target surface may also be safe to apply to conductive surfaces and may eliminate sparks, fires, or other hazards that are created when an electroadhesion device 900 that is generating a high voltage contacts and/or is placed close to a conductive target surface. When the sensor 914 detects a different surface with different characteristics, the digital switch 916 controls the voltage converter 908 to generate a different adjustable voltage that is sufficient to attach and secure the electroadhesion device 900 to that different surface. For example, in response to detecting an organic target surface (e.g., wood, drywall, fabric, and the like) by the sensor 914, the digital switch 916 may cause the voltage converter 908 to generate an adjustable voltage that may be sufficient to attach and secure the electroadhesion device 900 to the organic target surface without creating hazards. The adjustable voltage generated in response to detecting the organic target surface may also minimize the voltage output to avoid hazards that may be created when the electroadhesion device 900 is accidently moved. In response to detecting a smooth target surface (e.g., glass) or an insulating target surface (e.g., plastic, stone, sheetrock, ceramics, and the like) by the sensor 914, the digital switch 916 may cause the voltage converter 908 to generate an adjustable voltage sufficient to attach and secure the electroadhesion device 900 to the smooth and/or insulating target surface without creating hazards. Thus, the electroadhesion device 900 has an adjustable voltage level that is adjusted based on a characteristic of the target surface determined by the sensor 914 resulting in an electroadhesion device 900 that can be safely used to attach to various target surfaces without safety hazards.

The strength (i.e. amount of voltage) of the adjustable voltage may vary depending on the material of the target surface. For example, the strength of the adjustable voltage required to attach the electroadhesion device 900 to a conductive target surface (e.g., metal) may be higher than the adjustable voltage required to attach the electroadhesion device 900 to an insulating target surface, a smooth target surface, and/or an organic target surface. The strength of the adjustable voltage required to attach the electroadhesion device 900 to an organic target surface may be greater than the adjustable voltage required to attach the electroadhesion device 900 to a conductive target surface and less than the adjustable voltage require to attach the electroadhesion device 900 to an insulating target surface. The strength of the adjustable voltage required to attach the electroadhesion device 900 to an insulating target surface may be higher than the adjustable voltage required to attach the electroadhesion device 900 to an organic target surface or a conductive target surface. The electroadhesion device 900 may be configured to attach to any type of surface e.g., metallic, organic, rough, smooth, undulating, insulating, conductive, and like). In some embodiments, it may be preferable to attach the electroadhesion device 900 to a smooth, flat surface.

Attaching the electroadhesion device 900 to some target surfaces requires a very high voltage. For example, a very high voltage output may be required to attach the electroadhesion device 900 to a rough target surface, a very smooth target surface (e.g., glass), and/or an insulating target surface. An electroadhesion device 900 generating a high voltage output may generate sparks, fires, electric shock, and other safety hazards when placed into contract with—and/or in close proximity to—conductive surfaces. To avoid safety hazards, some embodiments of the electroadhesion device 900 may not generate a high voltage and may only generate an output voltage sufficient to attach the electroadhesion device 900 to conductive target surfaces, organic target surfaces, and the like.

When the electroadhesion device 900 is moved to a new target surface, the sensor 914 may automatically detect one or more characteristics of the new target surface and/or determine the material type for the new target surface. The digital switch 916 may then modify and/or maintain the voltage output generated by the voltage converter 908 based on the material type and/or characteristics for the new target surface. To determine the adjustable voltage to generate using the voltage converter 908, the digital switch 916 may include logic for determining the voltage based on sensor data received from the sensor 914. For example, the digital switch 916 may include logic for using a look up table to determine the proper adjustable voltage based on the sensor data. The logic incorporated into the digital switch 916 may also include one or more algorithms for calculating the proper adjustable voltage based on the sensor data. Additionally, if the sensor 914 detects the electroadhesion device 900 is moved away from a target surface, the digital switch 916 may power down the voltage converter 908 and/or otherwise terminate voltage output from the voltage converter 908 until a new target surface is detected by the sensor 914.

The one or more sensors 914 can include a wide variety of sensors 914 for measuring characteristics of the target surface. Each sensor 914 may be operated by a sensor control circuit 918. The sensor control circuit 918 may be integrated into the sensor 914 or may be a distinct component. The sensor control circuit 918 can be a microcontroller or other integrated circuit having programmable logic for controlling the sensor 914. For example, the sensor control circuit may initiate capture of sensor data, cease capture of sensor data, set the sample rate for the sensor, control transmission of sensor data measured by the sensor 914, and the like. Sensors 914 can include conductivity sensors (e.g., electrode conductivity sensors, induction conductivity sensors, and the like); Hall effect sensors and other magnetic field sensors; porosity sensors (e.g., time domain reflectometry (TDR) porosity sensors); wave form sensors (e.g., ultrasound sensors, radar sensors, infrared sensors, dot field projection depth sensors, time of flight depth sensors); motion sensors; and the like. Sensor data measured by the one or more sensors 914 may be used to determine one or more characteristics of the target surface. For example, sensor data may be used to determine the target surface's conductivity and other electrical or magnetic characteristics; the material's porosity, permeability, and surface morphology; the material's hardness, smoothness, and other surface characteristics; the distance the target surface is from the sensor; and the like. One or more characteristics determined from sensor data may be used to control the digital switch 916 directly. Sensor data may be analyzed by one or more applications of other pieces of software (e.g., a data analysis module) included in the camera, user device, display, and or remote computer device (e.g., a server). In particular, sensor data collected by the one or more sensors 914 may be refined and used to determine a characteristic and/or material type (e.g., metal, wood, plastic, ceramic, concreate, drywall, glass, stone and the like) for the target surface. The digital switch 916 may then control the voltage output from the voltage converter 908 based on the characteristic and/or material type for the target surface determined by the data analysis module.

The digital switch 916 may function as an essential safety feature of the electroadhesion device 900. The digital switch 916 may reduce the risk of sparks, fires, electric shock, and other safety hazards that may result from applying a high voltage to a conductive target surface. By autonomously controlling the voltage generated by the electroadhesion device 900, the digital switch 916 may also minimize human error that may result when a user manually sets the voltage output of the electroadhesion device 900. For example, human errors may include a user forgetting to change the voltage setting, a user, for example, a child, playing with the electroadhesion device and not paying attention to the voltage setting, a user mistaking a conductive surface for an insulating surface, and the like. These errors may be eliminated by using the digital switch 916 to automatically adjust the voltage generated by the voltage converter 908 based on sensor data received from the one or more sensors 914 and/or material classifications made by the data analysis module.

To promote safely and improve user experience, the electroadhesion device 900 and or the camera 102 or display 106 integrated with the electroadhesion device 900 may include a mechanism (e.g., button, mechanical switch, UT element, and the like) for actuating the sensor 914 and/or digital switch 916. The sensor 914 and digital switch 916 may also be automatically turned on when the electroadhesion device 900, the camera 102, and or display 106 is powered on. The electroadhesion device 900, the camera 102, and display 106 may also include a signaling mechanism (e.g., status light, UI element, mechanical switch, and the like) for communicating the status of the sensor 914 and or digital switch 916 to a user of the electroadhesion device 900. The signaling mechanism may be used to communicate that the proper adjustable voltage for a particular target surface has been determined.

In various embodiments, the signaling mechanism may be a status light that is red when the sensor 914 and or digital switch 916 is powered on and sensing the target surface material but has not determined the proper adjustable volt for the target surface. The status light may turn green when the digital switch 916 has received the sensor data, determined the appropriate voltage for the particular target surface, and generated the proper adjustable voltage output and the electroadhesion device 900 is ready to attach to the target surface. The status light may also turn blinking red and or yellow if there is some problem with determining the voltage for the particular target surface and or generating the adjustable voltage output for the particular target surface. For example, the status light may blink red and or turn yellow when the sensor 914 is unable to collect sensor data, the data analysis module is unable to determine a material type for the target surface material, the digital switch 916 is unable to operate the voltage converter 908, the voltage converter 908 is unable to generate the correct voltage, and the like.

As described herein, voltage generated by the voltage converter 908 is defined as a range of DC voltage of any one or more of the following from 250 V to 10,000 V; from 500 V to 10,000 V; from 1,000 V to 10,000 V; from 1,500 V to 10,000 V; from 2,000 V to 10,000 V; from 3,000 V to 10,000 V; from 4,000 V to 10,000 V; from 5,000 V to 10,000 V; from 6,000 V to 10,000 V; from 7,000 V to 10,000 V; from 250 V to 1,000 V; from 250 V to 2,000 V; from 250 V to 4,000 V; from 500 V to 1,000 V; from 500 V to 2,000 V; from 500 V to 4,000 V; from 1,000 V to 2,000 V; from 1,000 V to 4,000 V; from 1,000 V to 6,000 V; from 2,000 V to 4,000 V; from 2,000 V to 6,000 V; from 4,000 V to 6,000 V; from 4,000 V to 10,000 V; from 6,000 V to 8,000 V; and from 8,000 V to 10,000 V.

As described herein, voltage generated by the voltage converter 908 is defined as a range of AC voltage of any one or more of the following from 250 Vᵣₘₛ to 10,000 Vᵣₘₛ; from 500 Vᵣₘₛ to 10,000 Vᵣₘₛ; from 1,000 Vᵣₘₛ to 10,000 Vᵣₘₛ; from 1,500 Vᵣₘₛ to 10,000 Vᵣₘₛ; from 2,000 Vᵣₘₛ to 10,000 Vᵣₘₛ; from 3,000 Vᵣₘₛ to 10,000 Vᵣₘₛ; from 4,000 Vᵣₘₛ to 10,000 Vᵣₘₛ; from 5,000 Vᵣₘₛ to 10,000 Vᵣₘₛ; from 6,000 Vᵣₘₛ to 8,000 Vᵣₘₛ; from 7,000 Vᵣₘₛ to 8,000 Vᵣₘₛ; from 8,000 Vᵣₘₛ to 10,000 Vᵣₘₛ; from 9,000 Vᵣₘₛ to 10,000 Vᵣₘₛ; from 250 Vᵣₘₛ to 1,000 Vᵣₘₛ; from 250 Vᵣₘₛ to 2,000 Vᵣₘₛ; from 250 Vᵣₘₛ to 4,000 Vᵣₘₛ; from 500 Vᵣₘₛ to 1,000 Vᵣₘₛ; from 500 Vᵣₘₛ to 2,000 Vᵣₘₛ; from 500 Vᵣₘₛ to 4,000 Vᵣₘₛ; from 1,000 V to 2,000 Vᵣₘₛ; from 1,000 Vᵣₘₛ to 4,000 Vᵣₘₛ; from 1,000 V to 6,000 Vᵣₘₛ; from 2,000 Vᵣₘₛ to 4,000 Vᵣₘₛ; from 2,000 Vᵣₘₛ to 6,000 Vᵣₘₛ; from 4,000 V to 6,000 Vᵣₘₛ; from 4,000 Vᵣₘₛ to 8,000 Vᵣₘₛ; and from 6,000 Vᵣₘₛ to 8,000 Vᵣₘₛ.

As described herein, voltage generated by the voltage converter 908 is defined as a range of DC voltage of any one or more of the following from about 250 V to about 10,000 V; from about 500 V to about 10,000 V; from about 1,000 V to about 10,000 V; from about 1,500 V to about 10,000 V; from about 2,000 V to about 10,000 V; from about 3,000 V to about 10,000 V; from about 4,000 V to about 10,000 V; from about 5,000 V to about 10,000 V; from about 6,000 V to about 8,000 V; from about 7,000 V to about 8,000 V; from about 250 V to about 1,000 V; from about 250 V to about 2,000 V; from about 250 V to about 4,000 V; from about 500 V to about 1,000 V; from about 500 V to about 2,000 V; from about 500 V to about 4,000 V; from about 1,000 V to about 2,000 V; from about 1,000 V to about 4,000 V; from about 1,000 V to about 6,000 V; from about 2,000 V to about 4,000 V; from about 2,000 V to about 6,000 V; from about 4,000 V to about 6,000 V; from about 4,000 V to about 8,000 V; from about 6,000 V to about 8,000 V; from about 8,000 V to about 10,000 V; and from about 9,000 V to about 10,000 V.

As described herein, voltage generated by the voltage converter 908 is defined as a range of AC voltage of any one or more of the following from about 250 Vᵣₘₛ to about 10,000 Vᵣₘₛ; from about 500 Vᵣₘₛ to about 10,000 Vᵣₘₛ; from about 1,000 Vᵣₘₛ to about 10,000 Vᵣₘₛ; from about 1,500 Vᵣₘₛ to about 10,000 Vᵣₘₛ; from about 2,000 Vᵣₘₛ to about 10,000 Vᵣₘₛ; from about 3,000 Vᵣₘₛ to about 10,000 Vᵣₘₛ; from about 4,000 Vᵣₘₛ to about 10,000 Vᵣₘₛ; from about 5,000 Vᵣₘₛ to about 10,000 Vᵣₘₛ; from about 6,000 Vᵣₘₛ to about 8,000 Vᵣₘₛ; from about 7,000 Vᵣₘₛ to about 8,000 Vᵣₘₛ; from about 250 Vᵣₘₛ to about 1,000 Vᵣₘₛ; from about 250 Vᵣₘₛ to about 2,000 Vᵣₘₛ; from about 250 Vᵣₘₛ to about 4,000 Vᵣₘₛ; from about 500 Vᵣₘₛ to about 1,000 Vᵣₘₛ; from about 500 Vᵣₘₛ to about 2,000 Vᵣₘₛ; from about 500 Vᵣₘₛ to about 4,000 Vᵣₘₛ; from about 1,000 Vᵣₘₛ to about 2,000 Vᵣₘₛ; from about 1,000 Vᵣₘₛ to about 4,000 Vᵣₘₛ; from about 1,000 Vᵣₘₛ to about 6,000 Vᵣₘₛ; from about 2,000 Vᵣₘₛ to about 4,000 Vᵣₘₛ; from about 2,000 Vᵣₘₛ to about 6,000 Vᵣₘₛ; from about 4,000 Vᵣₘₛ to about 6,000 Vᵣₘₛ; from about 4,000 Vᵣₘₛ to about 8,000 Vᵣₘₛ; from about 6,000 Vᵣₘₛ to about 8,000 Vᵣₘₛ; from about 8,000 Vᵣₘₛ to about 10,000 Vᵣₘₛ; and from about 9,000 Vᵣₘₛ to about 10,000 Vᵣₘₛ.

As described herein, voltage output from the power supply 912 is defined as a range of DC voltage of any one or more of the following from 2.0 V to 249.99 V; from 2.0 V to 150.0 V; from 2.0 V to 100.0 V; from 2.0 V to 50.0 V; from 5.0 V to 249.99 V; from 5.0 V to 150.0 V; from 5.0 V to 100.0 V; from 5.0 V to 50.0 V; from 50.0 V to 150.0 V; from 100.0 V to 249.99 V; from 100.0 V to 130.0 V; and from 10.0 V and 30.0 V.

As described herein, voltage output from the power supply 912 is defined as a range of AC voltage of any one or more of the following from 2.0 Vᵣₘₛ to 249.99 Vᵣₘₛ; from 2.0 Vᵣₘₛ to 150.0 Vᵣₘₛ; from 2.0 Vᵣₘₛ to 100.0 Vᵣₘₛ; from 2.0 V to 50.0 Vᵣₘₛ; from 5.0 V. to 249.99 Vᵣₘₛ; from 5.0 Vᵣₘₛ to 150.0 Vᵣₘₛ; from 5.0 Vᵣₘₛ to 100.0 Vᵣₘₛ; from 5.0 Vᵣₘₛ to 50.0 Vᵣₘₛ; from 50.0 Vᵣₘₛ to 150.0 Vᵣₘₛ; from 100.0 Vᵣₘₛ to 249.99 Vᵣₘₛ; from 100.0 Vᵣₘₛ to 130.0 Vᵣₘₛ; and from 10.0 Vᵣₘₛ and 30.0 Vᵣₘₛ.

As described herein, voltage output from the power supply 912 is defined as a range of DC voltage of any one or more of the following from about 2.0 V to about 249.99 V; from about 2.0 V to about 150.0 V; from about 2.0 V to about 100.0 V; from about 2.0 V to about 50.0 V; from about 5.0 V to about 249.99 V; from about 5.0 V to about 150.0 V; from about 5.0 V to about 100.0 V; from about 5.0 V to about 50.0 V; from about 50.0 V to about 150.0 V; from about 100.0 V to about 249.99 V; from about 100.0 V to about 130.0 V; and from about 10.0 V and 30.0 V.

As described herein, voltage output from the power supply 912 is defined as a range of AC voltage of any one or more of the following from about 2.0 Vᵣₘₛ to about 249.99 Vᵣₘₛ; from about 2.0 Vᵣₘₛ to about 150.0 Vᵣₘₛ; from about 2.0 Vᵣₘₛ to about 100.0 Vᵣₘₛ; from about 2.0 V to about 50.0 Vᵣₘₛ; from about 5.0 Vᵣₘₛ to about 249.99 Vᵣₘₛ; from about 5.0 Vᵣₘₛ to about 150.0 Vᵣₘₛ; from about 5.0 Vᵣₘₛ to about 100.0 Vᵣₘₛ; from about 5.0 Vᵣₘₛ to about 50.0 Vᵣₘₛ; from about 50.0 Vᵣₘₛ to about 150.0 Vᵣₘₛ; from about 100.0 Vᵣₘₛ to about 249.99 Vᵣₘₛ; from about 100.0 Vᵣₘₛ to about 130.0 Vᵣₘₛ; and from about 10.0 Vᵣₘₛ and 30.0 Vᵣₘₛ.

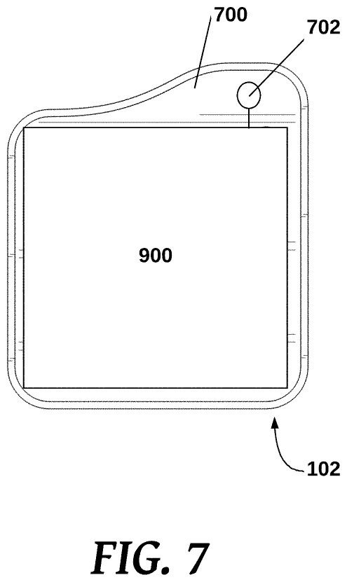

FIG. 7 illustrates a back surface 700 of the camera 102 having an electroadhesion device 900, for example, a compliant electroadhesive film fixed to the back surface 700. The sensor 702 for determining the target surface material shown on the camera 102 may be separate from and or integrated into the electroadhesive film.

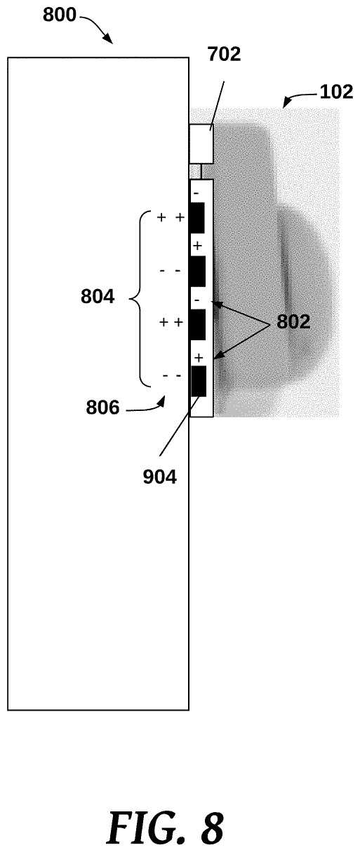

FIG. 8 illustrates a side view of the camera 102 mounted to a target surface 800 (e.g., a surface of the display 106) using the electroadhesion device 900. In this example, the electroadhesion device 900 is mounted to the camera 102. To attach the camera 102 to the target surface 800, the sensor 702 determines the material of the target surface 800. To determine the material, the sensor 702 may emit a signal, pulse, or other waveform transmission towards the target surface 800. The sensor 702 may then detect a signal reflected back off of the target surface 800 as sensor data. Sensor data collected by the sensor 702 is then used to determine one or more characteristics and or material types for the target surface 800. Based on the characteristics and or material types identified using sensor data, the voltage generated and applied to each of the electrodes 904 is adjustably controlled using the digital switch 916. Adjusting the voltage output of the electrodes 904 according to the material of the target surface 800, eliminates sparks, fires, electric shock, and other safety hazards that may result when too much voltage is applied to conductive target surfaces. The sensor 702 may also be used to detect an authorized user of the electroadhesion device 900 to minimize human error, accidental voltage generation, and unintended operation of the electroadhesion device 900.

To attach the camera 102 to the target surface 800, a electroadhesive force may be generated by the one or more electrodes 904 in response to the adjustable voltage. The voltage uses alternating positive and negative charges 802 on adjacent electrodes 904. The voltage difference between the electrodes 904 induces a local electric field 804 in the portion of the target surface 800 around the one or more electrodes 904. The electric field 804 locally polarizes the target surface 800 and causes an electrostatic adhesion between the electrodes 904 of the electroadhesion device 900 and the induced charges 806 on the target surface 800. For example, the electric field 804 may locally polarize the target surface 800 to cause electric charges 806 (e.g., electric charges induced by the electric field 804 having opposite polarity to the charge on the electrodes 904) from the inner portion of target surface 800 to build up on an exterior surface of the target surface around the surface of the electrodes 904. The build-up of opposing charges creates an electroadhesive force between the electroadhesion device 900 attached to the camera 102 and the target surface 800.

The electroadhesive force is sufficient to fix the camera 102 to the target surface 800 while the voltage is applied. It should be understood that the electroadhesion device 900 does not have to be in direct content with the target surface to produce the electroadhesive force. Instead, the electroadhesion device 900 must be proximate to the target surface 800 to interact with the voltage on the one or more electrodes 904 that provides the electroadhesive force. The electroadhesion device 900 may, therefore, secure the camera 102 to smooth, even surfaces as well as rough, uneven surfaces. The electroadhesion device 900 may also be curved or irregularly shaped to match the contours of curved surfaces to facilitate more power efficient, safer, and stronger electroadhesion attachment to irregularly shaped target surfaces. The electroadhesion device 900 may also include a suspension (e.g., a spring suspension) or adjustable surface to improve the power efficiency, safety, and or strength of electroadhesion interactions with irregularly shaped target surfaces.

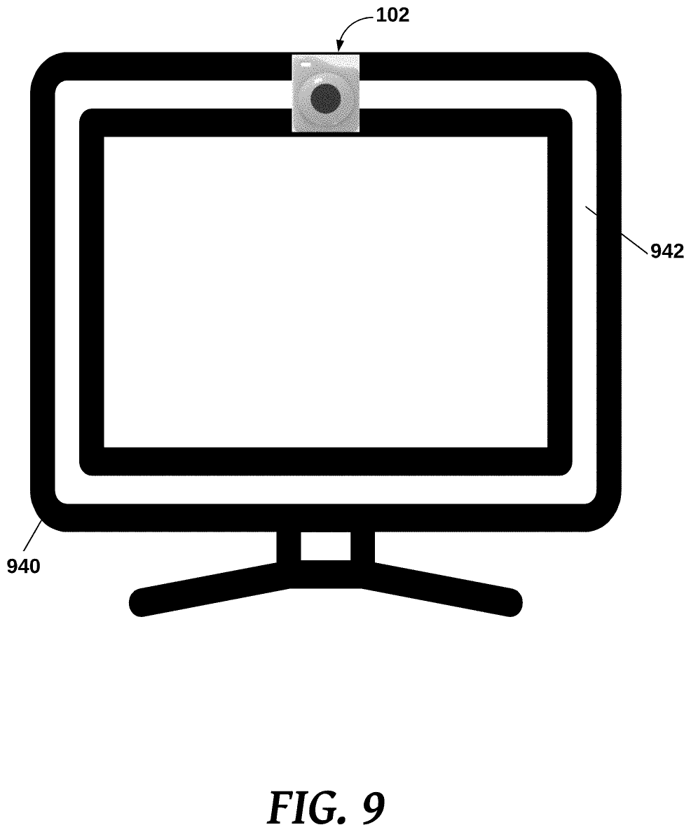

FIG. 9 illustrates a camera 102 mounted to a television 940 or other display 106. As shown, the camera 102 may be attached to a front surface 942 of the television 940 using an electroadhesion device or other attachment mechanism (e.g., mechanical attachment mechanism, adhesive, and the like). Embodiments having the electroadhesion device integrated into the camera 102 may allow the camera 102 to be placed on any surface of the television 940 or other display. The camera 102 may also be moved to different locations on the television 940 or other display by de-activating the electroadhesion device, moving the camera 102 to a new location, and then re-activating the electroadhesion device.

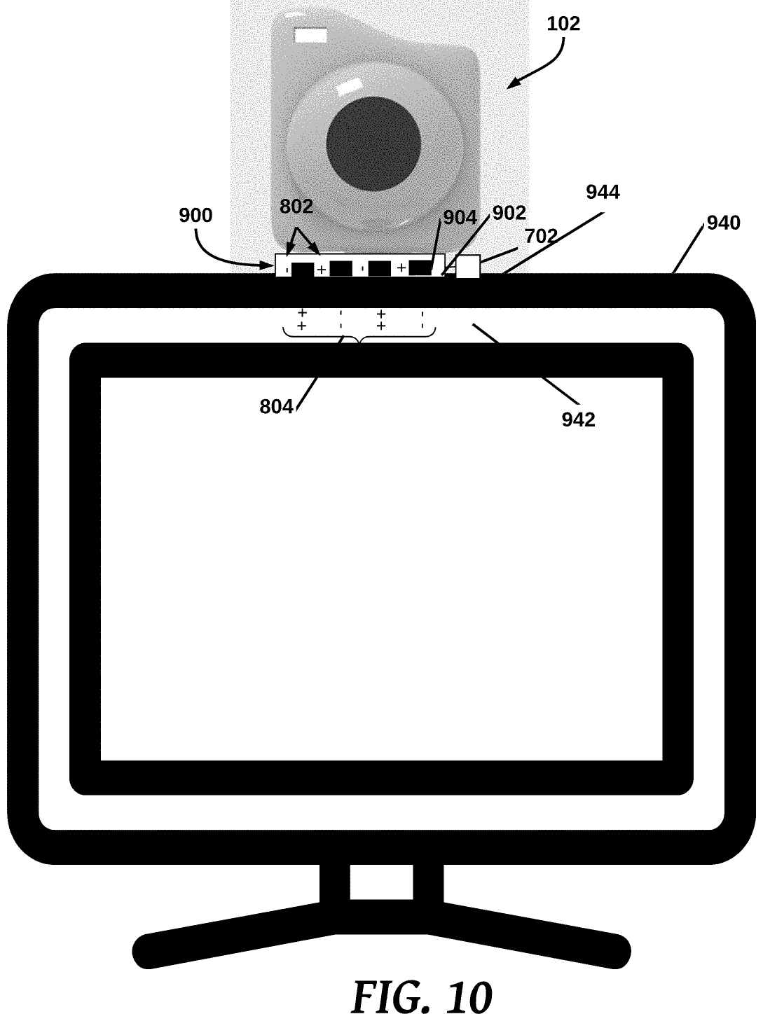

FIG. 10 illustrates an electroadhesion device 900 integrated into the television 940. As shown the television 940 may have an electroadhesion device 900 integrated into a top portion 944 of the television 940. The electroadhesion device 900 may be used to mount the television 940 to a wall or other surface and or attach the camera 102 and other objects to the television 940. The electroadhesion device 900 may be in the form of a compliant film comprising one or more electrodes 904 and an insulating material 902 between the electrodes 904. The electroadhesion film may include a chemical adhesive applied to the insulating material 902 and/or electrodes 904 to allow the electroadhesion device 900 to be attached to the front surface 942 of the television 940.

To safely attach the camera 102 to the front surface 942, the voltage generated and applied to each of the electrodes 904 is adjustably controlled using the digital switch 916. By adjusting the voltage output of the electrodes 904 according to the material of the front surface 942, the digital switch 916 eliminates sparks, fires, electric shock, and other safety hazards that may result when too much voltage is applied to conductive target surfaces. An electroadhesive force may be generated by the one or more electrodes 904 in response to the adjustable voltage. The voltage produces alternating positive and negative charges 802 on adjacent electrodes 904. The voltage difference between the electrodes 904 induces the local electric field 804 on the front surface 942 around the one or more electrodes 904. The electric filed 804 locally polarizes the front surface 942 and causes an electrostatic adhesion between the electrodes 904 of the electroadhesion device 900 and the induced charges on the front surface. For example, the electric field 804 may locally polarize the front surface 942 to cause the electric charges 802 (e.g., electric charges induced by the electric field 804 having opposite polarity to the charge on the electrodes 904) from the inner portion of the front surface 942 to build up on the front surface 942 around the surface of the electrodes 904. The build-up of opposing charges creates an electroadhesive force between the electroadhesion device 900 attached to the television 940 and the camera 102.

The electroadhesive force is sufficient to fix the camera 102 to the television 940 while the voltage is applied. It should be understood that the electroadhesion device 900 does not have to be in direct content with the camera 102 or other target surface to produce the electroadhesive force. Instead, the camera 102 or other target surface must be proximate to the electroadhesion device 900 to interact with the voltage on the one or more electrodes 904 that provides the electroadhesive force. The electroadhesion device 900 may, therefore, secure the television 940 to smooth, even surfaces as well as rough, uneven surfaces.

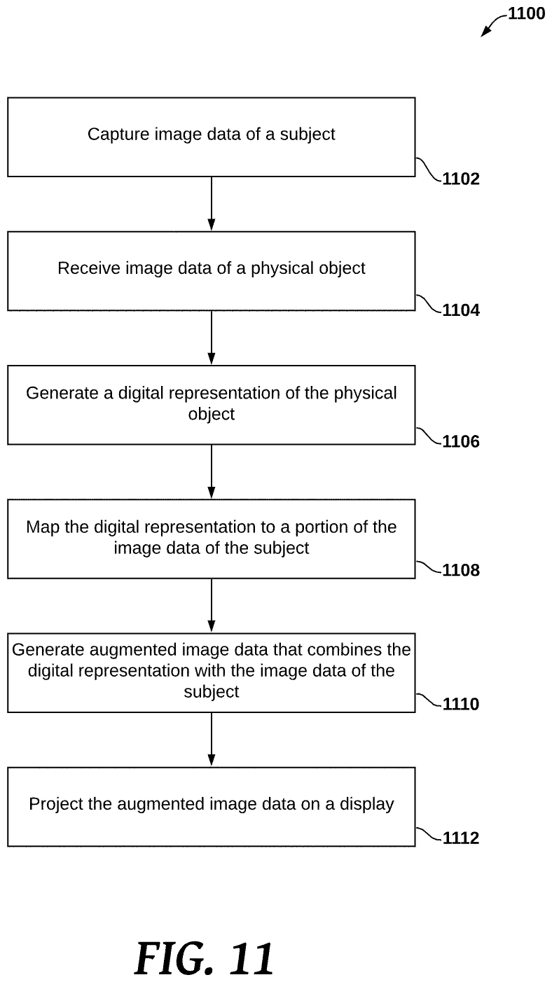

FIG. 11 illustrates an exemplary process for digitally trying on one or more physical objects 1100 using the digital mirror system shown in FIGS. 1-2. At 1102, the camera captures content data of a subject. For example, the camera may capture live video of a person or other user of the digital mirror system. A user device may connect to a camera to control the operation of the camera and receive content data of the subject. At 1104, the user device may also receive content data of a physical object the user desires to digitally try on. For example, the user device may receive content data of a piece of clothing, accessory, or other physical object from an e-commerce application, native camera of the user device, or other source of content data. At 1106, the digital clothing client of the user device may generate a 3D representation of the physical object from the content data of the physical object.

The 3D representation of the physical object may then be mapped to a portion of the content data of the subject at 1108. To determine which portion of the content data of the subject to map the 3D representation of the physical object to, the augmentation unit of the digital clothing client may classify the type of physical object (e.g., shirt, pants, watch, shoes, and the like) based on the content data of the subject. The augmentation unit may then map the 3D representation to a particular portion of the content data of the subject that corresponds to physical objects having the particular classification type determined for the physical object. For example, the augmentation unit may classify the physical object as a shirt and may map the 3D representation of the shirt to the torso of the subject's body captured in the content data of the subject. The portion of the content data of the subject to map to the 3D representation of the digital object may also be selected by the user in a digital clothing client UI that receives inputs thereto and is presented on a display of the user device.

Once the portion of the content data of the subject to map to the 3D representation of the physical object is determined, one or more edge detection, image segmentation, or other image processing algorithms may be used to separate the portion of the content data used for mapping from the rest of the content data. The 3D representation may then be mapped to the segmented portion of the content data of the subject using one or more pixel matching, point matching, or other image or other content data matching techniques. Instructions for mapping the 3D representation of the physical object to the portion of the content data of the subject including, for example, point/pixel coordinates, transformations and other calculations required for matching and or scaling, and the like may be written to a mapping file that is recorded in memory and or stored in a database. The mapping instructions may be generated and or modified dynamically to enable the digital representation to follow the movements of the subject so that the digital representation of the physical object appears attached to and to fit the portion of the subject that is mapped to the digital representation. By dynamically, modifying the position of the digital representation of the physical object in response to movements of the subject, the augmented content data replicates the appearance of wearing the physical object on the body of the subject and thereby simulates trying on the physical object in front of a physical mirror.

Once the mapping instructions are generated by the augmentation unit, the rendering engine may generate augmented content data based on the mapping instructions. 1110 the augmented content data may be, for example, an augmented reality display, 3D image, hologram, static image, or other visual representation that combines the digital representation of the physical object with the content data of the subject. The augmented content data generated by the rendering engine may use the mapping instructions to overlay the digital representation of the physical object over the portion of the content data of the subject that corresponds to the physical object. For example, the augmented content data may be an augmented reality display that shows a 3D representation of a shirt overlaid over the torso of the subject. The augmented reality display be implemented as a live video that shows a digital representation of the physical object overlaid over the portion of the subject. The position of the digital representation of the physical object may be dynamically adjusted to follow the movement of the subject within the live video.

To simulate trying on the physical object in front of a mirror, the augmented content data may be projected on a display at 1112. For example, the live video augmented reality display of the digital representation of the shirt overlaid on the torso of the subject may be projected on a television or other display to provide a digital try on experience that simulates physically trying on the shirt in the dressing room of a retail store. The live video of the subject that is modified with the digital representation of the shirt may be captured by a camera mounted to a front surface of the television of other display to transform the television into a digital mirror that allows the subject to digitally try on the shirt and other physical objects. To facilitate changing the perspective of the subject shown in the digital mirror and to securely attach the camera to the television or other display without damaging the television, the camera may be attached to the television using the electroadhesion device described above.

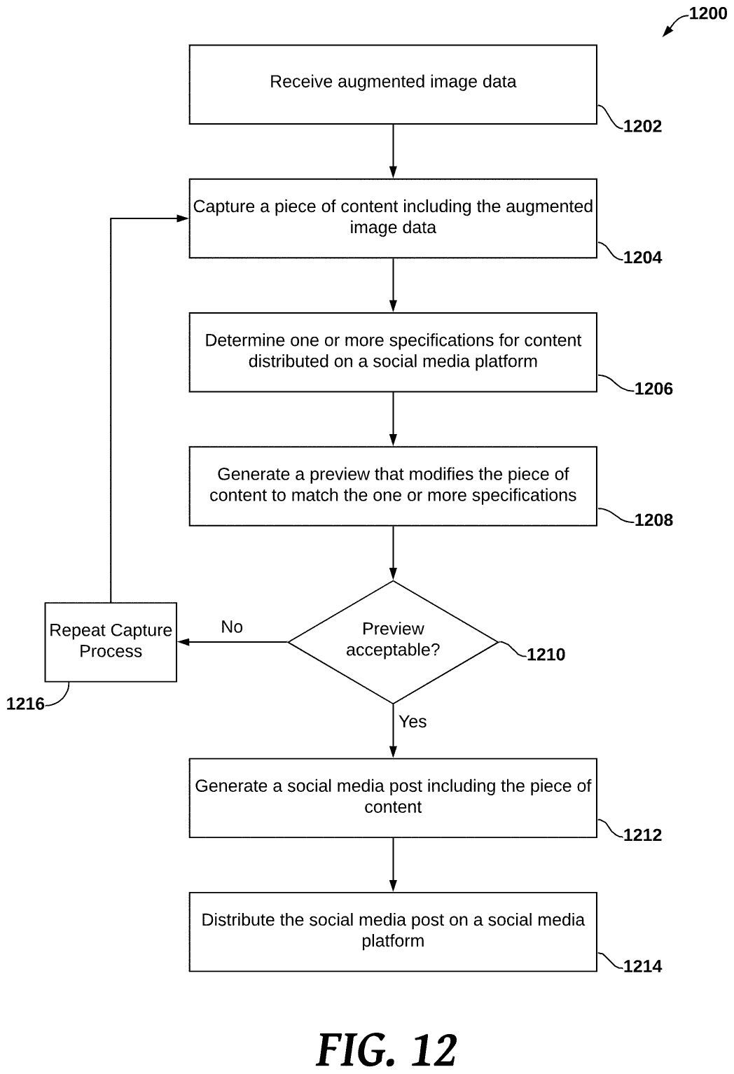

FIG. 12 is a flow chart illustrating an exemplary process for sharing content generated using a digital mirror 1200. As shown augmented content data is received at 1202. The augmented content data may be, for example, an augmented reality display of a digital representation of a physical object overlaid over a portion of image data of a subject. At 1204, a user device may capture a piece of content included in the augmented image data. For example, the user device may capture a piece of content for example, video of the subject showing a portion of the subject's body overlaid with the digital representation of the physical object, static image of the subject with the digital representation of the physical object shown over a portion of the subject, or other piece of content including the augmented content data.

At 1204, one or more specifications for content distributed on a social medial platform may be determined. For example, one or more elements of content post GUIs presented by a social medial platform may be parsed to determine the content dimensions, aspect ratio, resolution, and other specifications of content distributed on the social medial platform. At 1208, a posting API may generate a preview that modifies the piece of content including the augmented content data to match the one or more specifications of content distributed on the social media platform determined from parsing the GUI elements. For example, the posting API may modify the dimensions and aspect ratio of video recording capturing the augmented content data to generate a preview that displays the appearance of the video recording when distributed on the social media platform. The user may review the preview at 1210 to determine if the appearance of the piece of content is acceptable. If the preview is not acceptable, the capture process may be repeated at step 1216 by repeating steps 1204-1208. A new preview of second piece of content may then be evaluated at 1210.

If the preview is acceptable, the posting API may generate a social media post including the piece of content. The social medial post may be generated according to the specifications shown in the preview. The social media post may be a static image, video recording or other piece of pre-recorded content. The social media post may also be a live stream video (e.g., a live stream of the augmented reality display). At 1214, the social media post may then be distributed on a social media platform so that a plurality of users and or devices executing local instances of the social media platform (e.g., a social media app) may access the post and view and or interact with the piece of content including the augmented content data.

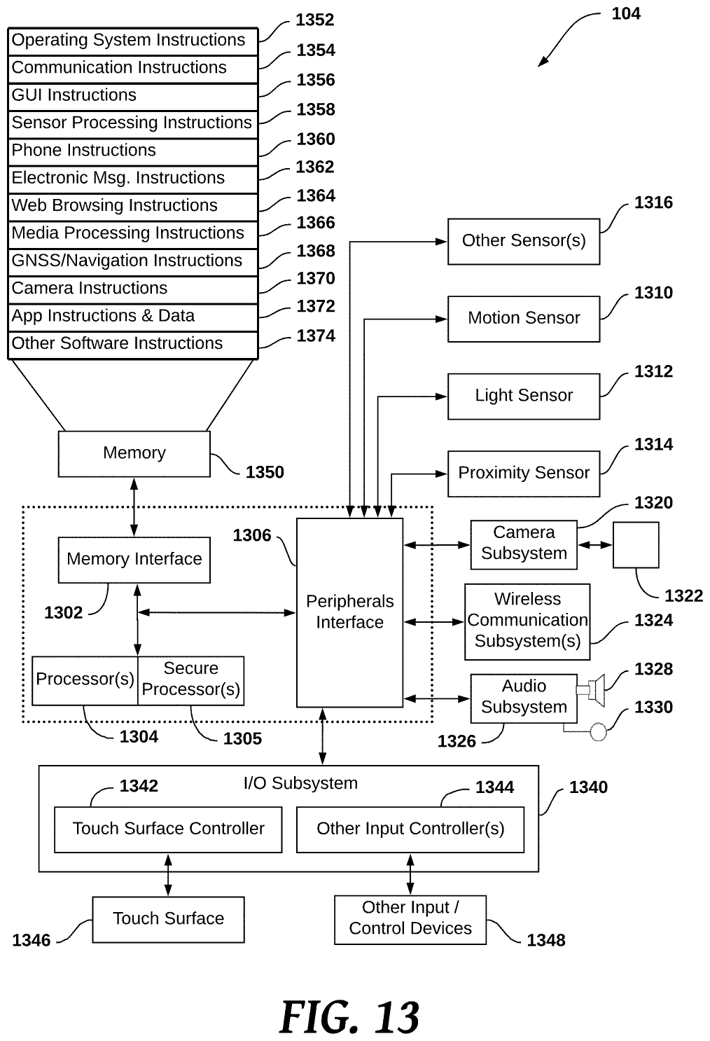

FIG. 13 shows an illustrative computer 1300 that may be used to implement the user device 104, digital media player 404, camera 102 and other components of the camera system 100. The computer 1300 may be any electronic device that runs software applications derived from compiled instructions, including without limitation personal computers, servers, smart phones, media players, electronic tablets, game consoles, email devices, etc. In some implementations, the computer 1300 may include one or more processors 1302, volatile memory 1304, non-volatile memory 1306, and one or more peripherals 1308. These components may be interconnected by one or more computer buses 1310.

Processor(s) 1302 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 1310 may be any known internal or external bus technology, including but not limited to ISA, EISA, PO, PCI Express, USB, Serial ATA or FireWire, Volatile memory 1304 may include, for example, SDRAM. Processor 1302 may receive instructions and data from a. read-only memory or a random access memory or both. The essential elements of a computer may include a processor for executing instructions and one or more memories for storing instructions and data.

Non-volatile memory 1306 may include, by way of example, semiconductor memory devices, such as EPROM, EEPROM, and flash memory devices; magnetic disks such as internal hard disks and removable disks; magneto-optical disks; and (D-ROM and ,DVD-ROM disks. Non-volatile memory 1306 may store various computer instructions including operating system instructions 1312, communication instructions 1314, application instructions 1316, and application data 1317. Operating system instructions 1312 may include instructions for implementing an operating system (e.g., Mac OS®, Windows®, or Linux).

The operating system may be multi-user, multiprocessing, multitasking, multithreading, real-time, and the like. Communication instructions 1314 may include network communications instructions, for example, software for implementing communication protocols, such as TCP/IP, HTTP, Ethernet, telephony, etc. Application instructions 1316 can include social media and/or video streaming platform content characteristics, camera control commands, instructions for sharing content, and other information used or generated by other applications persisted on a user device. For example, application instructions 1316 may include instructions for recognizing GUIs displaying content on a specific social media and/or video streaming platform; capturing characteristics of content displayed in relevant GUIs; browsing physical objects on an e-commerce platform; generating digital representations of physical objects; generating augmented image data; modifying content previews, editing captured content, and/or generating, capturing, and sharing content using the systems shown in FIG. 1 and FIG. 2. Application data 1317 may correspond to data stored by the applications running on the computer 1300. For example, application data 1317 may include content, commands for providing image content, augmented image data, digital representations of physical objects, commands controlling a camera, commands for controlling a robotic arm, commands for synchronizing a camera with a robotic arm, image data received from a camera, content characteristics retrieved from a social media and/or content video streaming platform, and/or instructions for sharing content.

Peripherals 1308 may be included within the computer 1300 or operatively coupled to communicate with the computer 1300. Peripherals 1308 may include, for example, network interfaces 1318, input devices 1320, and storage devices 1322. Network interfaces 1318 may include, for example, an Ethernet or WiFi adapter for communicating over one or more wired or wireless networks. Input devices 1320 may be any known input device technology, including but not limited to a keyboard (including a virtual keyboard), mouse, trackball, and touch-sensitive pad or display. Storage devices 1322 may include one or more mass storage devices for storing data files; such devices include magnetic disks, such as internal hard disks and removable disks; magneto-optical disks; and optical disks.

FIGS. 14-15 illustrate additional components included in an exemplary camera 102. As shown in FIG. 14, the camera 102 may include one or more image sensors 1404 fitted with one lens 1402 per sensor. The lens 1402 and image sensor 1404 can capture image data including images, video, and other content data. Each image sensor 1404 and lens 1402 may have associated parameters, such as the sensor size, resolution, and interocular distance, the lens focal lengths, lens distortion centers, lens skew coefficient, and lens distortion coefficients. The parameters of each image sensor and lens may be unique for each image sensor or lens and are often determined through a stereoscopic camera calibration process. The camera 102 can further include a processor 1406 for executing commands and instructions to provide communications, capture, data transfer, and other functions of the camera device as well as memory 1408 for storing digital data and streaming video. For example, the storage device can be, e.g., a flash memory, a solid-state drive (SSD) or a magnetic storage device. The camera 102 may include a communications interface 1410 for communicating with external devices. For example, the camera 102 can include a wireless communications component for connecting to an external device (e.g., a laptop, an external hard drive, a tablet, a smart phone, or other remote computer) for transmitting the data and/or messages to the external device. The camera 102 may also include an audio component 1412 (e.g., a microphone or other known audio sensor) for capturing audio content. A bus 1414, for example, a high-bandwidth bus, such as an Advanced High-performance Bus (AHB) matrix interconnects the electrical components of the camera 102.

FIG. 15 shows more details of the processor 1406 of the camera device shown in FIG. 14. A video processor controls the camera 102 components including a lens 1402 and/or image sensor 1404 using a camera control circuit 1510 according to commands received from a camera controller. The power management integrated circuit (PMIC) 910 is responsible for controlling a battery charging circuit 1522 to charge a battery 1524. The battery 1524 supplies electrical energy for running the camera 102. The PMIC 910 may also control an electro adhesion control circuit 1590 that supplies power to an electroadhesion device 900. The processor 1406 can be connected to an external device via a USB controller 1526. In some embodiments, the battery charging circuit 1522 receives external electrical energy via the USB controller 1526 for charging the battery 1524.

The camera 102 may include a volatile memory 1530 (e.g. double data rate memory or 4R memory) and a non-volatile memory 1532 (e.g., embedded MMC or eMMC, solid-state drive or SSD, etc.). The processor 1406 can also control an audio codec circuit 1540, which collects audio signals from microphone 1512 and microphone 1512 for stereo sound recording. The camera 102 can include additional components to communicate with external devices. For example, the processor 1406 can be connected to a video interface 1550 (e.g., Wifi connection, UDP interface, TCP link, high-definition multimedia interface or HDMI, and the like) for sending video signals to an external device. The camera 102 can further include an interface conforming to Joint Test Action Group (JTAG) standard and Universal Asynchronous Receiver/Transmitter (UART) standard. The camera 102 can include a slide switch 1560 and a push button 1562 for operating the camera 102. For example, a user may turn on or off the camera 102 by pressing the push button 1562. The user may switch on or off the electroadhesion device 900 using the slide switch 1560. The camera 102 can include an inertial measurement unit (IMU) 1570 for detecting orientation and/or motion of the camera 102. The processor 1406 can further control a light control circuit 1580 for controlling the status lights 1582. The status lights 1582 can include, e.g., multiple light-emitting diodes (LEDs) in different colors for showing various status of the camera 102.

The foregoing description is intended to convey a thorough understanding of the embodiments described by providing a number of specific exemplary embodiments and details involving capturing image data, generating digital representations of physical objects, generating augmented image data, and projecting augmented image data on a display to provide a digital try on experience. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A user device and server device are used as examples for the disclosure. The disclosure is not intended to be limited GUI display screens, image capture systems, image processing system, data extraction processors, and user devices only. For example, many other electronic devices may utilize a system to capture image data, generate digital representations of physical objects, generate augmented image data, and project augmented image data on a display to provide a digital try on experience.

Methods described herein may represent processing that occurs within a system (e.g., system 100 of FIGS. 1-2). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a. computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described herein, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including, by ways of example, semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

As used herein, the terms “and/or” and “at least one of” include any and all combinations of one or more of the associated listed items.

Certain details are set forth in the foregoing description and in FIGS. 1-15 to provide a thorough understanding of various embodiments of the present invention. Other details describing well-known structures and systems often associated with image processing, electronics components, device controls, content capture, content distribution, and the like, however, are not set forth below to avoid unnecessarily obscuring the description of the various embodiments of the present invention.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A digital mirror comprising:
a camera having an attachment mechanism configured to secure the camera to a display, the camera including:
a body;
an image sensor within the body configured to capture a piece of content of a subject;
a communications component within the body configured to connect to the display; and
a processor and memory including instructions executable by the processor that is configured to:
receive a piece of content data of a physical object;
receive the piece of content data of the subject captured by the image sensor;
generate a digital representation of the physical object using the content data of the physical object;
generate a piece of augmented content data that combines the digital representation of the physical object and the piece of content data of the subject by overlaying the digital representation of the physical object over a portion of the subject included in the piece of content data of the subject; and
communicate the augmented content data to the display.

2. The digital mirror of claim 1, wherein the attachment mechanism comprises an electroadhesion device.

3. The digital mirror of claim 2, wherein the electroadhesion device comprises:
a compliant film including one or more electrodes disposed in an insulating material having a chemical adhesive applied to at least one side;
a power supply connected to the one or more electrodes;
a sensor integrated into the electroadhesion device, the sensor configured to collect sensor data measuring one or more characteristics of a target surface; and
a digital switch configured to control a voltage output of the one or more electrodes based on sensor data,
wherein the voltage output of the one or more electrodes generates an electroadhesive force that secures the electroadhesion device to the target surface.

4. The digital mirror of claim 1, wherein the camera further comprises a depth sensor that operates to determine a distance away from the camera of the subject; and
wherein the piece of content data of the subject includes the distance.

5. The digital mirror of claim 1, wherein the digital representation of the physical object is a three dimensional representation of the physical object.

6. The digital mirror of claim 1, wherein the processor is further configured to:
segment a portion of the subject from a remaining portion of the piece of content data of the subject;
map the digital representation of the physical object to the segmented portion of the subject to generate a mapping file; and
render the piece of augmented content data by overlaying the digital representation of the physical object over the segmented portion of the subject based on the mapping file.

7. The digital mirror of claim 6, wherein the processor is further configured to dynamically modify the mapping file in response to a change in position by the segmented portion of the subject.

8. The digital mirror of claim 1, wherein the physical object is at least one of a piece of clothing worn by a user and an object adjacent to the user.

9. A digital mirror system comprising:
a camera including:
a body;
an attachment mechanism fixed to the body, wherein the attachment mechanism is configured to secure the camera to a display;
an image sensor within the body configured to capture a piece of content of a subject; and
a communications component within the body configured to connect to a remote computer and transmit the piece of content to the remote computer; and
the remote computer having a processor and memory including instructions executable by the processor that is configured to:
receive a piece of content of a physical object;
connect to the communications component of the camera to receive the piece of content of the subject from the camera;
generate a digital representation of the physical object using the piece of content of the physical object;
generate a piece of augmented content data that combines the digital representation of the physical object and the piece of content of the subject by overlaying the digital representation of the physical object over a portion of the subject included in the piece of content of the subject; and
communicate the augmented content data to the display.

10. The system of claim 9, wherein the processor is further configured to control the camera by transmitting a control command that encodes an operation of the camera to the communications component of the camera.

11. The system of claim 9, wherein the attachment mechanism comprises an electroadhesion device.

12. The system of claim 11, wherein the electroadhesion device includes:
a compliant film including one or more electrodes disposed in an insulating material having a chemical adhesive applied to at least one side;
a power supply connected to the one or more electrodes;
a sensor integrated into the electroadhesion device, the sensor configured to collect sensor data measuring one or more characteristics of a target surface; and
a digital switch configured to control a voltage output of the one or more electrodes based on sensor data,
wherein the voltage output of the one or more electrodes generates an electroadhesive force that secures the electroadhesion device to the target surface.

13. The system of claim 9, wherein the camera further comprises a depth sensor configured to determine a distance away from the camera of the subject; and
wherein the piece of content data of the subject includes the distance.

14. The system of claim 9, wherein the digital representation of the physical object is a 3D representation.

15. The system of claim 9, wherein the physical object is at least one of a piece of clothing worn by a user and an object adjacent to the user.

16. The system of claim 9, wherein the processor is further configured to:
segment a portion of the subject from a remaining portion of the piece of content data of the subject;
map the digital representation of the physical object to the segmented portion of the subject to generate a mapping file; and
render the piece of augmented content data by overlaying the digital representation of the physical object over the segmented portion of the subject based on the mapping file.

17. The system of claim 16, wherein the processor is further configured to dynamically modify the mapping file in response to a change in position by the segmented portion of the subject.

18. A method comprising;
capturing a piece of content data of a subject with a camera secured to a display by an attachment mechanism;
receiving a piece of content data of a physical object;
generating a digital representation of the physical object using the content data of the physical object;
generating a piece of augmented content data that combines the digital representation of the physical object and the piece of content data of the subject by overlaying the digital representation of the physical object over a portion of the subject included in the piece of content data of the subject; and
communicating the augmented content data to the display.

19. The method of claim 18, wherein the attachment mechanism comprises an electroadhesion device.

20. The method of claim 19, wherein the electroadhesion device includes:
a compliant film including one or more electrodes disposed in an insulating material having a chemical adhesive applied to at least one side;
a power supply connected to the one or more electrodes;
a sensor integrated into the electroadhesion device, the sensor configured to collect sensor data measuring one or more characteristics of a target surface; and
a digital switch configured to control a voltage output of the one or more electrodes based on sensor data,
wherein the voltage output of the one or more electrodes generates an electroadhesive force that secures the electroadhesion device to the target surface.

21. The method of claim 18, wherein the digital representation of the physical object is a 3D representation.

22. The method of claim 18, further comprising generating the piece of augmented content data by:
segmenting the portion of the subject from a remaining portion of the piece of content data of the subject;
mapping the digital representation of the physical object to the segmented portion of the subject to generate a mapping file; and
rendering the piece of augmented content data by overlaying the digital representation of the physical object over the segmented portion of the subject based on the mapping file.

23. The method of claim 22, further comprising dynamically modifying the mapping file in response to a change in position by the segmented portion of the subject.

24. The method of claim 18, further comprising:
connecting to a social media platform;
generating a preview of a piece of content including the piece of augmented content data; and
sharing, on the social media platform, the piece of content after the piece of content is accepted by a user based on the preview.

25. The method of claim 18, wherein the physical object is at least one of a piece of clothing worn by a user and an object adjacent to the user.
